(19) United States
(12) Patent Application Publication
(10) Pub. No.: US 2025/0181831 A1
(43) Pub. Date: Jun. 5, 2025

(54) INFORMATION PROCESSING METHOD, INFORMATION PROCESSING APPARATUS, AND PROGRAM THAT COMBINES MULTIPLE COOKING STEPS

(71) Applicant: Panasonic Intellectual Property Corporation of America, Torrance, CA (US)

(72) Inventors: Kihiro YUASA, Kanagawa (JP); Yoshinori KOIZUMI, Tokyo (JP); Kenta MURAKAMI, Osaka (JP)

(73) Assignee: Panasonic Intellectual Property Corporation of America, Torrance, CA (US)

(21) Appl. No.: 19/045,393

(22) Filed: Feb. 4, 2025

Related U.S. Application Data
(63) Continuation of application No. PCT/JP2023/029813, filed on Aug. 18, 2023.

(30) Foreign Application Priority Data
Aug. 26, 2022 (JP) 2022-134871

(51) Int. Cl. G06F 40/279; G06Q 10/087; G06Q 50/10

(52) U.S. Cl. CPC G06F 40/279; G06Q 10/087; G06Q 50/10

(57) ABSTRACT

A recipe acquisition unit acquires a plurality of cooking steps. An operation block processing unit associates one or more blocks to each of the plurality of cooking steps. A situation acquisition unit acquires information on a situation of a user. A cooking block selection processing unit selects, in each of the plurality of cooking steps, a block suited to the situation of the user from the one or more blocks. A cooking program creation processing unit creates a cooking program suited to the situation of the user by combining the block selected in each of the plurality of cooking steps. An output unit outputs the cooking program created.

This application is based upon and claims the benefit of priority from the prior Japanese Patent Application No. 2022-134871, filed on Aug. 26, 2022, the entire contents of which are incorporated herein by reference.

### BACKGROUND

### 1. Field

The present disclosure relates to information processing technology and particularly to an information processing method, an information processing apparatus, and a program that combines a plurality of cooking steps.

### 2. Description of the Related Art

A server and a cooking appliance are connected via a network to provide cooking support services. The server uses a database such as the user's purchase history, the inventory of food stored in the user's refrigerator, the type of cooking appliance owned by the user, the cooking recipe for each type of cooking appliance, and the cooking history for each cooking appliance related to the user (see, for example, Patent Literature 1).
[Patent Literature 1] JP 2020-8989

According to Patent Literature 1, a cooking recipe that can be cooked with a cooking appliance owned at the user's home is provided. Depending on circumstances such as the user's schedule, however, it may not be possible to cook according to such a cooking recipe. It is therefore desired to provide a cooking recipe suited to the user's situation.

### SUMMARY

The present disclosure addresses the issue described above, and a purpose thereof is to provide a technology of providing a cooking recipe suited to the user's situation.

An information processing method according to an embodiment of the present disclosure includes: acquiring a plurality of cooking steps; associating one or more blocks to each of the plurality of cooking steps; acquiring information on a situation of a user; selecting, in each of the plurality of cooking steps, a block suited to the situation of the user from the one or more blocks; creating a cooking program suited to the situation of the user by combining the block selected in each of the plurality of cooking steps; and outputting the cooking program created.

Another embodiment of the present disclosure relates to an information processing apparatus. The apparatus includes: a first acquisition unit that acquires a plurality of cooking steps; a first processing unit that associates one or more blocks to each of the plurality of cooking steps; a second acquisition unit that acquires information on a situation of a user; a second processing unit that selects, in each of the plurality of cooking steps, a block suited to the situation of the user from the one or more blocks; a third processing unit that creates a cooking program suited to the situation of the user by combining the block selected in each of the plurality of cooking steps; and an output unit that outputs the cooking program created.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A-1G show a configuration of an appliance control system according to embodiment 1;

FIGS. 2A-2E show a configuration of the functional block used in the appliance control system of FIGS. 1A-1G;

FIGS. 3A-3H show a configuration of the functional block sequence used in the appliance control system of FIGS. 1A-1G;

FIG. 4 shows an overview of the operation of the appliance of FIGS. 1A-1G;

FIG. 5 shows a configuration of the information processing system of embodiment 1;

FIG. 6 shows a configuration of the information processing apparatus of FIG. 5;

FIG. 7 shows a data structure of a database stored in the cooking recipe storage unit of FIG. 6;

FIG. 8 shows a screen displayed on the terminal of FIG. 5;

FIGS. 9A-9B show an overview of a process executed by the operation block processing unit of FIG. 6;

FIG. 10 shows a data structure of a database stored in the cooking step storage unit of FIG. 6;

FIG. 11 shows an overview of another process executed by the operation block processing unit of FIG. 6;

FIG. 12 shows a data structure of a database stored in the cooking utensil storage unit of FIG. 6;

FIG. 13 shows an overview of a process executed by the cooking block selection processing unit of FIG. 6;

FIGS. 14A-14B show schedules shown in the situation information acquired by the situation acquisition unit of FIG. 6;

FIG. 15 shows another overview of a process executed by the cooking block selection processing unit of FIG. 6;

FIG. 16 shows yet another overview of a process executed by the cooking block selection processing unit of FIG. 6;

FIG. 17 shows yet another overview of a process executed by the cooking block selection processing unit of FIG. 6;

FIG. 18 shows a screen displayed on the terminal of FIG. 5;

FIG. 19 shows another screen displayed on the terminal of FIG. 5;

FIG. 20 shows yet another overview of a process executed by the cooking block selection processing unit of FIG. 5;

FIG. 21 shows yet another overview of a process executed by the cooking block selection processing unit of FIG. 6;

FIG. 22 shows yet another overview of a process executed by the cooking block selection processing unit of FIG. 6;

FIG. 23 is a flowchart showing a sequence of steps to output a cooking program executed by the information processing apparatus of FIG. 6;

FIG. 24 is a flowchart showing a sequence of steps to create a cooking step executed by the information processing apparatus of FIG. 6;

FIG. 25 is a flowchart showing a sequence of steps to select a cooking block executed by the information processing apparatus of FIG. 6;

FIGS. 26A-26B show an overview of a process according to variation 1;

FIGS. 27A-27B show another overview of a process according to variation 1;

FIG. 28 shows an overview of a process executed by the cooking block selection processing unit according to variation 2;

FIG. 29 shows another overview of a process executed by the cooking block selection processing unit according to variation 2;

FIG. 30 is a flowchart showing a sequence of steps to select a cooking block executed by the information processing apparatus according to variation 2;

FIG. 31 shows a configuration of the information processing system according to variation 3;

FIGS. 32A-32B show schedules indicated in the situation information acquired by the situation acquisition unit according to variation 4; and

FIG. 33 is a flowchart showing a sequence of steps to output a cooking program executed by the information processing apparatus according to embodiment 2.

### DETAILED DESCRIPTION

The invention will now be described by reference to the preferred embodiments. This does not intend to limit the scope of the present invention, but to exemplify the invention.

### Embodiment 1

All of the embodiments described below illustrate preferred embodiments of the present disclosure. Therefore, numerical values, shapes, materials, constituting elements, positions of arrangement and connection forms of constituting elements, and steps and order of steps shown in the following embodiments are examples only and are not presented to limit the present disclosure. Therefore, those of the components in the following embodiments not defined in the independent claims, which present the highest-level concept of the present disclosure, are described as optional constituting elements. Substantially identical features illustrated in the figures are denoted by identical symbols, and a duplicate description is omitted or simplified. Hereinafter, the embodiment is described in the order of: (1) overview of functional block and functional block sequence and (2) output of cooking program.

### (1) Overview of Functional Block and Functional Block Sequence

In household electrical/mechanical utensils such as a rice cooker, washing machine, and microwave oven (hereinafter referred to as “appliances”), the function/operation of hardware is controlled by software for realizing a specific function. In this embodiment, an appliance control system is introduced as a mechanism to enable creation or updating of software for controlling the appliance.

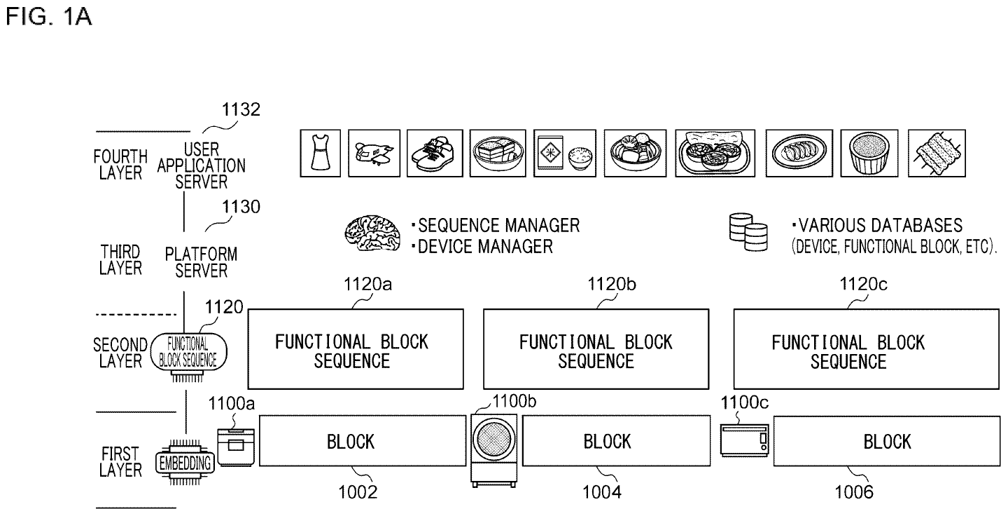

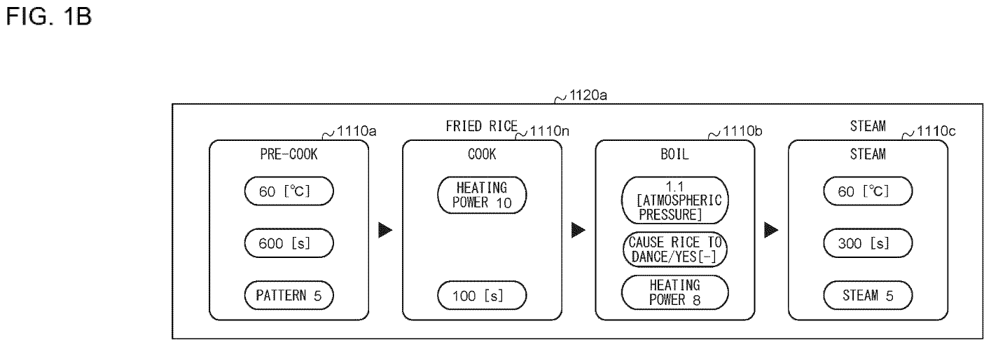

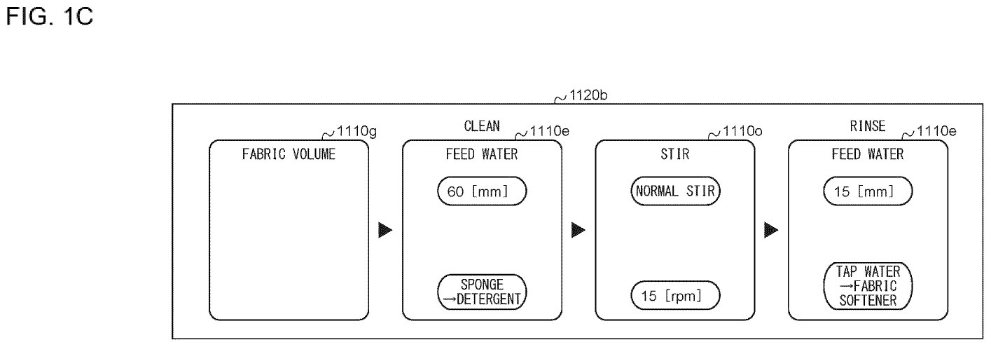

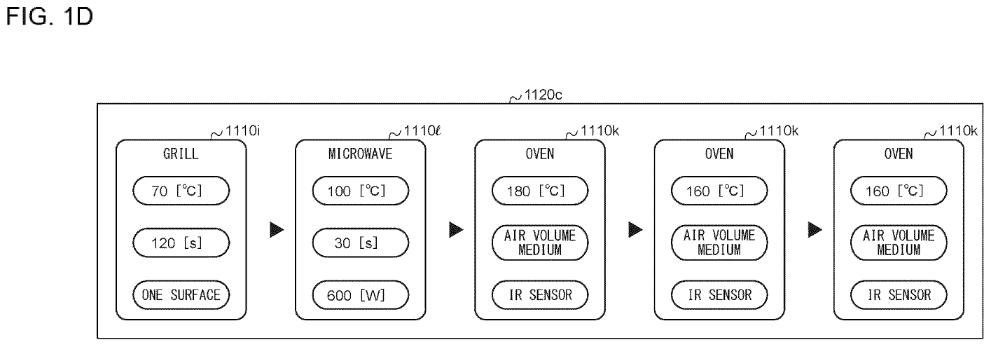

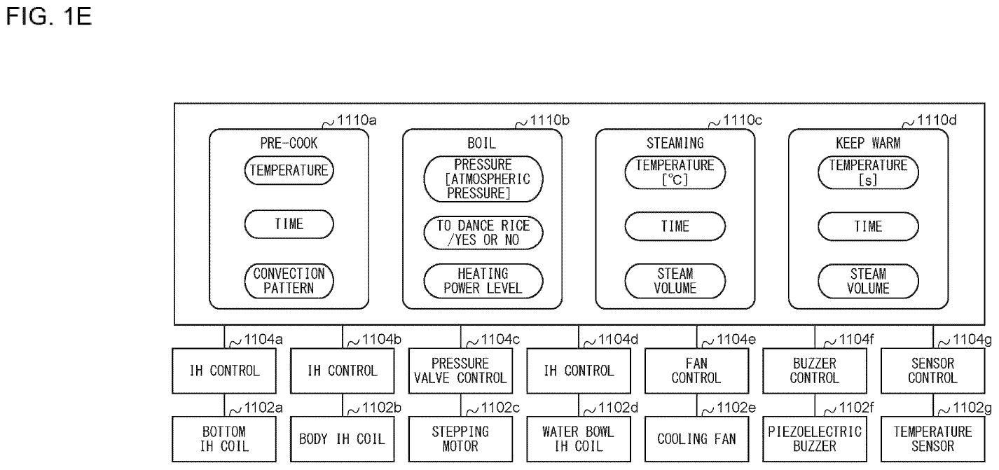

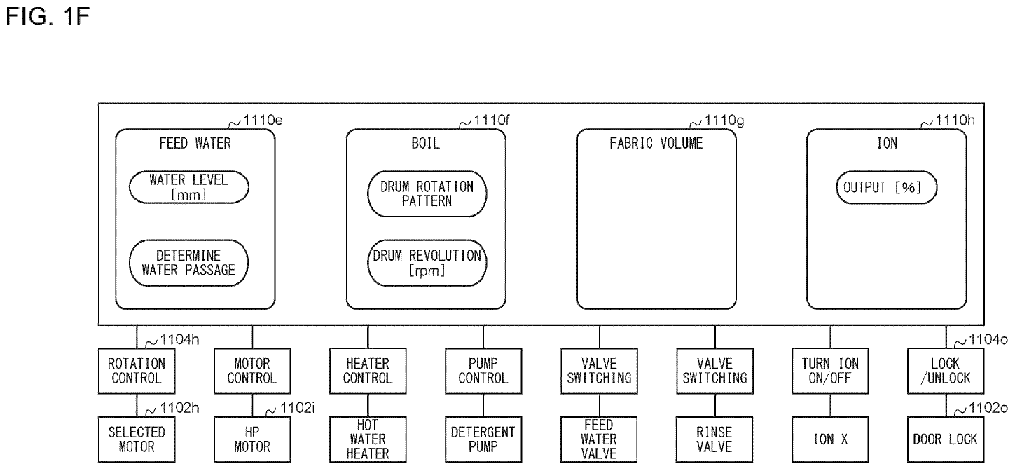

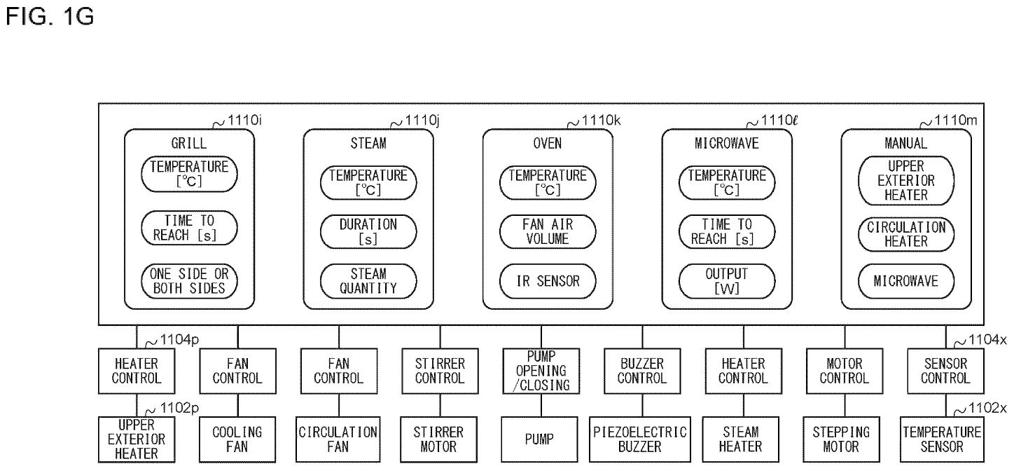

FIGS. 1A-1G show a configuration of an information processing system 1000. In the information processing system 1000, a four-layer model composed of the first to fourth layers is defined. In the first layer, the configuration of an appliance 1100 is defined. The appliance 1100 is, for example, a rice cooker (appliance 1100a), a washing machine (appliance 1100b), and a microwave oven (appliance 1100c). The appliance 1100 is not limited thereto. Each appliance 1100 includes a block 1002 (FIG. 1E), a block 1004 (FIG. 1F), a block 1006 (FIG. 1G), a plurality of components 1102, a plurality of drivers 1104, and a plurality of functional blocks 1110.

The component 1102 is a hardware element constituting a unit derived from dividing the operation (actuation/sensing) of the appliance 1100 and includes an actuator and a sensor that execute the function of the appliance 1100. The actuator is an output device, and the sensor is an input device. The actuator includes, for example, a bottom IH (Induction Heating) coil (component 1102a), a body IH coil (component 1102b), a stepping motor (component 1102c), a water bowl IH coil (component 1102d), a cooling fan (component 1102e), and a piezoelectric buzzer (component 1102F) in the rice cooker (appliance 1100a). The sensor is, for example, a temperature sensor (component 1102g) in the rice cooker (appliance 1100a). The component 1102 included in the rice cooker (appliance 1100a) is not limited to these, and the washing machine (appliance 1100b) and the microwave oven (appliance 1100c) are similarly configured.

The driver 1104 is software for directly controlling the component 1102. IH control (driver 1104) in the rice cooker (appliance 1100a) controls the bottom IH coil (component 1102a). Further, IH control (driver 1104b) controls the body IH coil (component 1102b), pressure valve control (driver 1104c) controls the stepping motor (component 1102c), and IH control (driver 1104d) controls the water bowl IH coil (component 1102d). Further, fan control (driver 1104e) controls the cooling fan (component 1102e), buzzer control (driver 1104f) controls the piezoelectric buzzer (component 1102f), and sensor control (driver 1104g) controls the temperature sensor (component 1102g). The driver 1104 included in the rice cooker (appliance 1100a) is not limited to these, and the washing machine (appliance 1100b) and the microwave oven (appliance 1100c) are similarly configured.

The functional block 1110 is a software interface (API: Application Programming Interface) associated with one or more drivers 1104 to cause one or more components 1102 to operate. The functional block 1110 can receive one or more parameters for controlling the operation of the (each) component 1102. Details of the functional block 1110 will be described later.

In the second layer, a functional block sequence 1120 comprised of an arrangement of one or more functional blocks 1110 in the order of operation is defined to cause the appliance 1100 to execute an intended process. That is, the functional block sequence 1120 defines the order of execution of one or more functional blocks 1110. The intended process is defined according to the appliance 1100, and is, for example, cooking in the case of the rice cooker (appliance 1100a) and the microwave oven (appliance 1100c) and washing in the case of the washing machine (appliance 1100b). The functional block sequence 1120a (FIG. 1B) is used in the rice cooker (appliance 1100a), the functional block sequence 1120b (FIG. 1C) is used in the washing machine (appliance 1100b), and the functional block sequence 1120c (FIG. 1D) is used in the microwave oven (appliance 1100c). The appliance 1100 executes the operation in the order of the functional blocks 1110 arranged in the functional block sequence 1120. Therefore, it is possible to update the function/operation of the appliance 1100 by changing the arrangement of the functional blocks 1110 or changing a parameter set in the functional block 1110. Details of the functional block sequence 1120 will be described later.

In the third layer, a platform server 1130 that manages various information in the information processing system 1000 is arranged. The platform server 1130 includes a sequence manager, a device manager, and various databases. The sequence manager manages the functional block sequence 1120, the device manager manages the registered information on the appliance 1100 that can use the functional block sequence 1120, and the various databases manage user information on users who can use the functional block sequence 1120.

In the fourth layer, a user application server 1132 in which each functional block sequence 1120 is presented as a user application is arranged. The functional block sequence 1120 presented in the user application server 1132 is downloaded to the appliance 1100. The downloaded functional block sequence 1120 is enabled in the appliance 1100. When a further functional block sequence 1120 is downloaded to the appliance 1100, the further functional block sequence 1120 is enabled in the appliance 1100.

The third and fourth layers of the information processing system 1000 may be integrated. In that process, the platform server 1130 and the user application server 1132 are integrally configured. Alternatively, the third and fourth layers in the information processing system 1000 may be arranged in the same layer. Alternatively, the third and fourth layers in the information processing system 1000 may be omitted. In that process, the functional block sequence 1120 is downloaded to the appliance 1100 from the user apparatus (not shown) owned by the user.

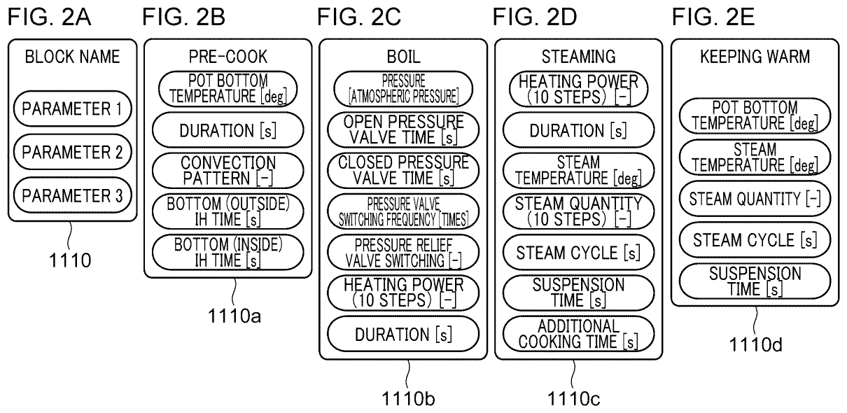

FIGS. 2A-2E show a configuration of the functional block 1110 used in the appliance control system 11000. FIG. 2A shows a basic configuration of the functional block 1110. The functional block 1110 is defined in a functional unit executable by the appliance 1100 and has a “block name” determined by the detail of the function. A plurality of parameters determined by the function can be set in the functional block 1110. Each parameter set in the functional block 1110 is output to the driver 1104. When the driver 1104 receives the parameter from the functional block 1110, the driver 1104 controls the operation of the component 1102 according to the parameter.

FIG. 2B shows a functional block 1110a of “pre-cook” in the rice cooker (appliance 1100a) of FIG. 1A. In the functional block 1110a of “pre-cook”, parameters including pot bottom temperature, duration, convection pattern, bottom (outside) IH time, and bottom (inside) IH time can be set. FIG. 2C shows a functional block 1110b of “boil” in the rice cooker (appliance 1100a) of FIG. 1A, FIG. 2D shows a functional block 1110c of “steam” in the rice cooker (appliance 1100a) of FIG. 1A, and FIG. 2E shows a functional block 1110d of “keep warm”. A plurality of parameters can be set in each of the functional block 1110b to the functional block 1110d as well. The same applies to the functional block 1110 in the washing machine (appliance 1100b) and the microwave oven (appliance 1100c) of FIG. 1A.

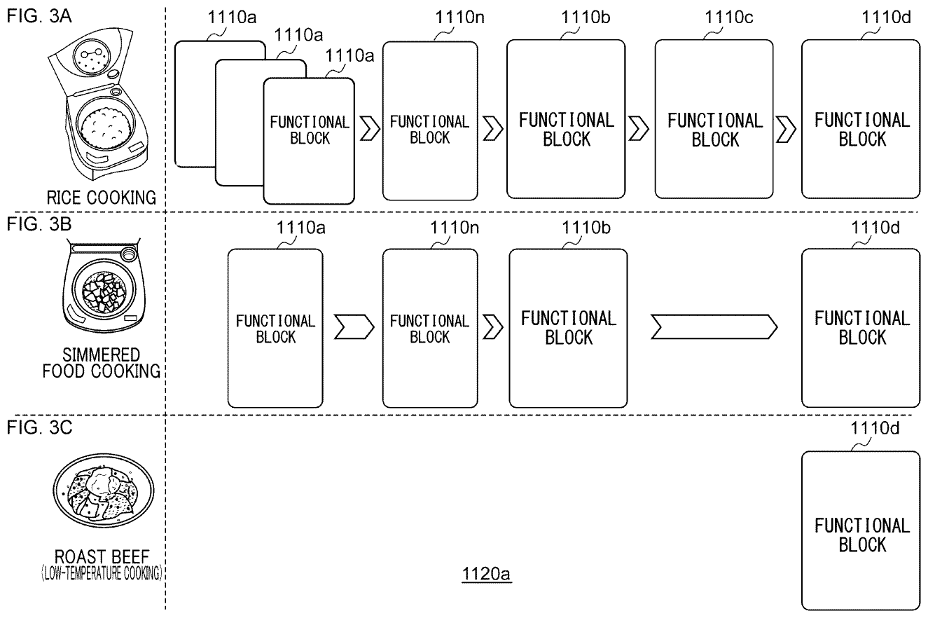

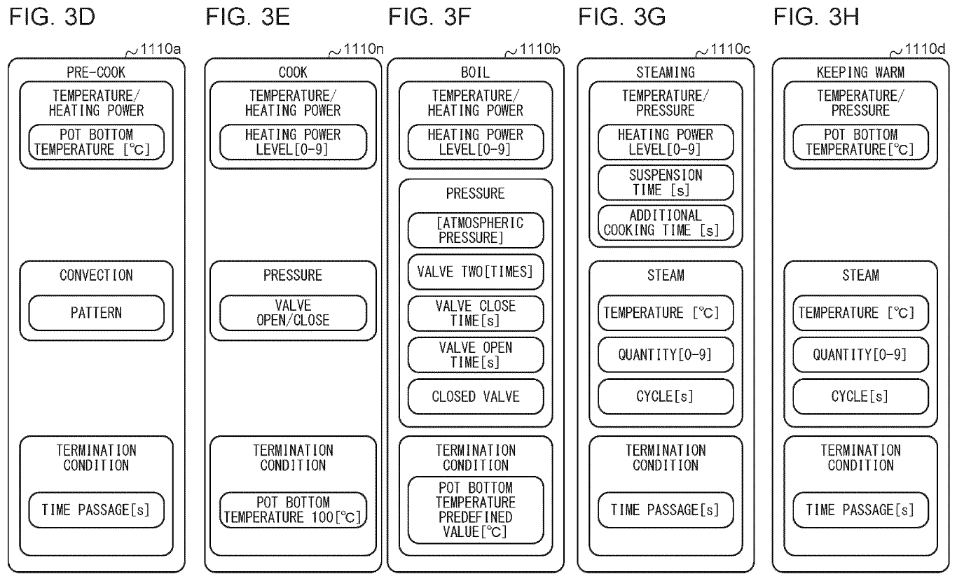

FIGS. 3A-3H show a configuration of the functional block sequence 1120 used in the information processing system 1000 and, particularly, the functional block sequence 1120a used in the rice cooker (appliance 1100a) of FIG. 1A. FIG. 3A shows a sequence for “rice cooking”, FIG. 3B shows a sequence for “simmered food cooking”, and FIG. 3C shows a sequence for “roast beef (low temperature cooking)”.

In the sequence for “rice cooking” shown in FIG. 3A, three “pre-cook” functional blocks 1110a (FIG. 3D), a “cook” functional block 1110n (FIG. 3E), the “boil” functional block 1110b (FIG. 3F), the “steam” functional block 1110c (FIG. 3G), and the “keep warm” functional block 1110d (FIG. 3H) are arranged in order. In the three “pre-cook”functional blocks 1110a, mutually different parameters are set. By thus arranging the three “pre-cook” functional blocks 1110a in which mutually different parameters are set in order, a three-step pre-cooking can be executed.

In the sequence for “simmered food cooking” shown in FIG. 3B, the “pre-cook” functional block 1110a, the “cook” functional block 1110n, the “boil” functional block 1110b, and the “keep warm” functional block 1110d are arranged in order. The sequence for “roast beef (low temperature cooking)” shown in FIG. 3C includes the “keep warm” functional block 1110d. By thus changing the type, arrangement, and parameters of the functional block 1110 used, it is possible to execute processes directed to different purposes of “rice cooking”, “simmered food cooking”, and “roast beef (low-temperature cooking)”. The same applies to the functional block sequence 1120 in the washing machine (appliance 1100b) and the microwave oven (appliance 1100c) of FIG. 1A.

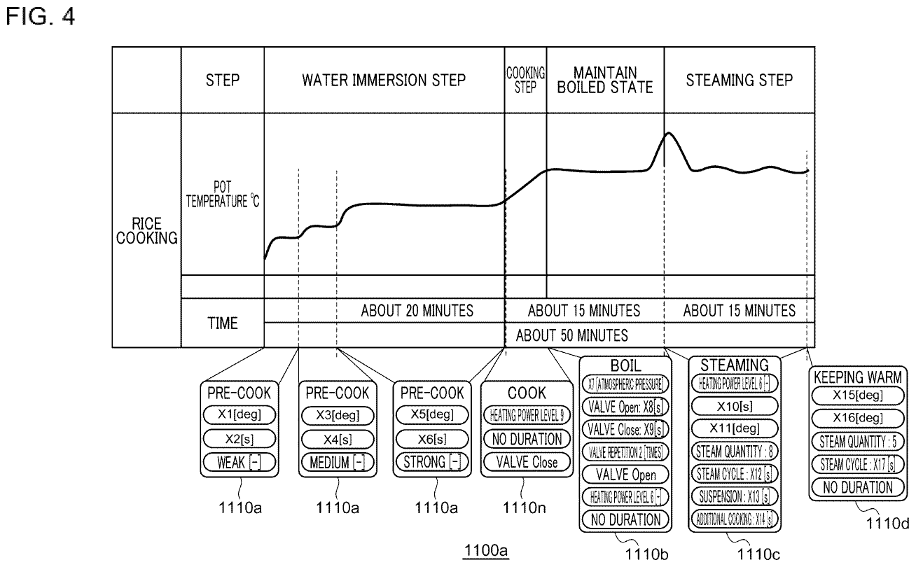

FIG. 4 shows an overview of the operation of the appliance 1100 and, particularly, the rice cooker (appliance 1100a) of FIG. 1A. This shows the operation of the appliance 1100a according to the sequence for “rice cooking” in FIG. 3A. In the water immersion step, the three “pre-cook” functional blocks 1110a with mutually different parameters set are executed in order so that the components 1102 corresponding to them operate according to the parameters. As a result, the pot temperature increases in a stepwise manner over time. Following this, the “cook” functional block 1110n, the “boil” functional block 1110b, the “steam” functional block 1110c, and the “keep warm” functional block 1110d are executed in order so that the components 1102 corresponding to them operate according to the parameters. That is, rice is cooked in the appliance 1100a by executing a plurality of functional blocks 1110 in order.

### (2) Output of Cooking Program

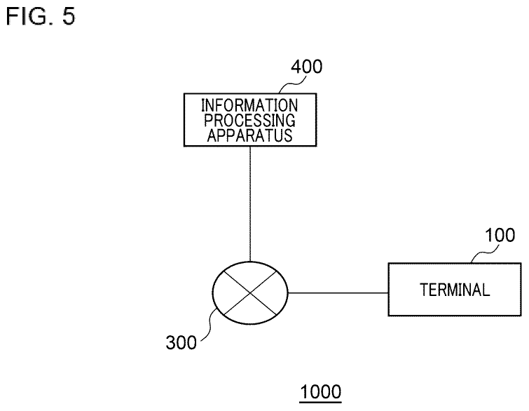

FIG. 5 shows a configuration of the information processing system 1000. The information processing system 1000 includes a terminal 100, a network 300, and an information processing apparatus 400. The terminal 100 and the information processing apparatus 400 are connected via a network 300 such as the Internet. In the information processing system 1000, the information processing apparatus 400 creates a cooking program that is a cooking recipe suited to the user's situation, and the information processing apparatus 400 provides the cooking program created to the terminal 100 used by the user via the network 300. The number of terminals 100 included in the information processing system 1000 is not limited to “1”.

The terminal 100 is an apparatus having a communication function that can be connected to the network 300 and is used by the user. The terminal 100 is a household electrical/mechanical utensil exemplified by a computer, a smartphone, a tablet terminal, a cooking appliance, etc. The terminal 100 includes a user control interface (not shown) such as a button that can receive information input by the user and a display unit (not shown) such as a display that can display information to the user. The user control interface and the display unit may be integrated as a touch panel. The terminal 100 manages the situation of the user and transmits information on the user's situation (hereinafter referred to as “situation information”) to the information processing apparatus 400 via the network 300. The “user's situation” is, for example, the “user's schedule” and the “cooking appliance that the user has”. The “user's schedule” includes information on the “degree of labor that the user can put into cooking”. To know the user's situation like this, the terminal 100 may include a cooking utensil storage unit and a schedule storage unit. Further, the terminal 100 receives a cooking program from the information processing apparatus 400 via the network 300 and displays the cooking program.

The information processing apparatus 400 is an apparatus having a communication function that can be connected to the network 300 and is, for example, a computer such as a server and a cloud server equipped with a processor, a memory, etc. The information processing apparatus 400 receives the situation information from the terminal 100 via the network 300. The information processing apparatus 400 creates a cooking program by reflecting the situation information and transmits the cooking program to the terminal 100 via the network 300.

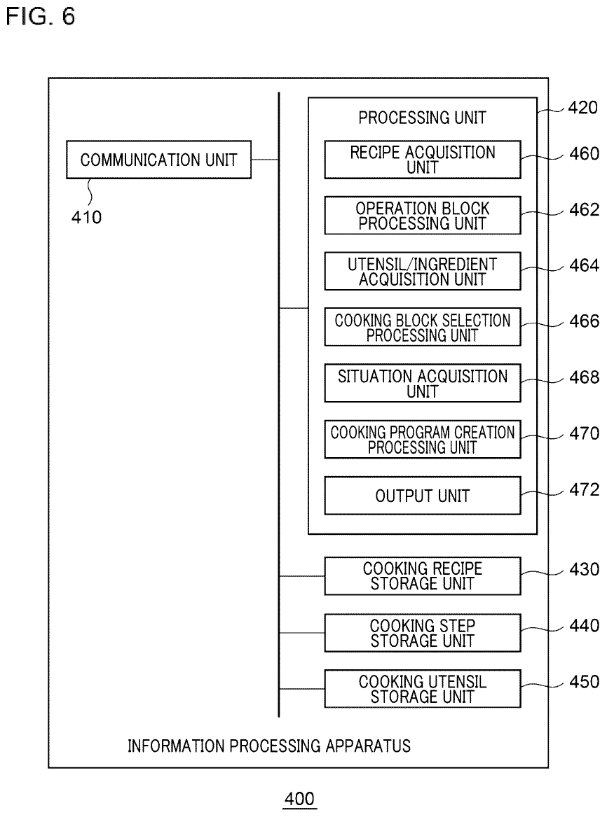

FIG. 6 shows a configuration of the information processing apparatus 400. The information processing apparatus 400 includes a communication unit 410, a processing unit 420, a cooking recipe storage unit 430, a cooking step storage unit 440, and a cooking utensil storage unit 450. The processing unit 420 includes a recipe acquisition unit 460, an operation block processing unit 462, a utensil/ingredient acquisition unit 464, a cooking block selection processing unit 466, a situation acquisition unit 468, a cooking program creation processing unit 470, and an output unit 472. The cooking recipe storage unit 430, the cooking step storage unit 440, and the cooking utensil storage unit 450 are an HDD (Hard Disk Drive) or an SSD (Solid State Drive) and can store electronic information. The communication unit 410 communicates with the terminal 100 via the network 300.

The recipe acquisition unit 460 acquires information on cooking ingredients available to the user for cooking (hereinafter referred to as “cooking ingredient information”) via the communication unit 410 and the network 300. For example, a camera inside a refrigerator installed in the user's residence captures an image inside the refrigerator, and the refrigerator transmits the image to the information processing apparatus 400 via the network 300. Alternatively, a home camera installed in the user's residence may capture an image inside the residence, and the home camera may transmit the image to the information processing apparatus 400 via the network 300. In these cases, the recipe acquisition unit 460 acquires the cooking ingredient information by executing an image recognition process on the image received by the communication unit 410. In the case the camera inside the refrigerator and the home camera are referred to as sensors, the image is called sensor information. The terminal 100 may acquire the cooking ingredient information from the user by manual input or voice input, and the terminal 100 may transmit the cooking ingredient information to the information processing apparatus 400 via the network 300. The recipe acquisition unit 460 may acquire the cooking ingredient information from both sensor information and inputs.

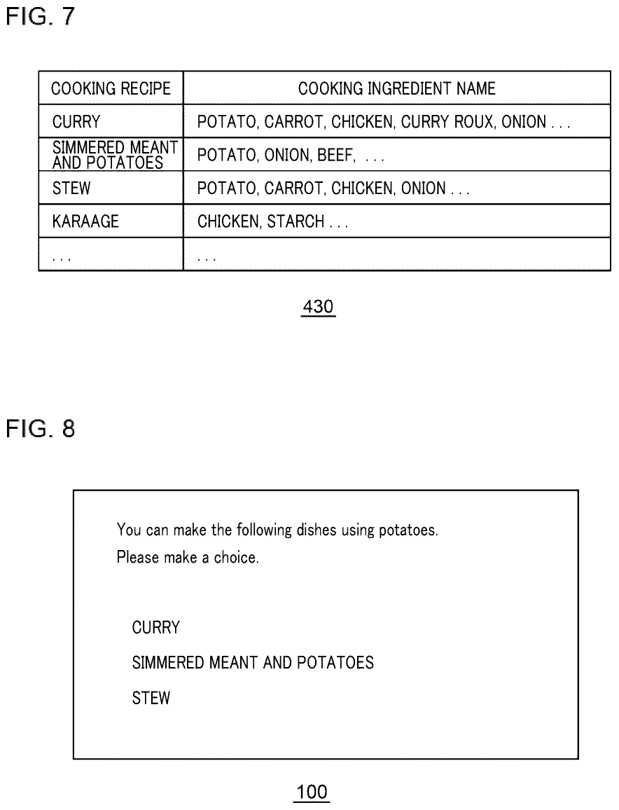

The cooking recipe storage unit 430 stores correspondence between each of a plurality of cooking recipes and the cooking ingredient. FIG. 7 shows a data structure of a database stored in the cooking recipe storage unit 430. In the cooking recipe field in the database, the name of a dish such as curry and simmered meat and potatoes is entered, and the name of the cooking ingredient used in each cooking recipe is entered in the cooking ingredient name field. The cooking recipe may be stored in advance in the cooking recipe storage unit 430 or may be added by the user as appropriate. Reference is made back to FIG. 6. The recipe acquisition unit 460 extracts a cooking ingredient name from the cooking ingredient information acquired and acquires a cooking recipe including the cooking ingredient name extracted as a cooking recipe candidate, by referring to the database stored in the cooking recipe storage unit 430. This corresponds to acquiring a cooking recipe that uses the cooking ingredient in the cooking ingredient information acquired. When the ingredient in the cooking ingredient information is “potato”, for example, curry, simmered meat and potatoes, stew, etc. are cooking recipe candidates. The recipe acquisition unit 460 transmits the cooking recipe candidate to the terminal 100 via the communication unit 410 and the network 300.

When the terminal 100 receives the cooking recipe candidate from the information processing apparatus 400, the terminal 100 displays the cooking recipe candidate on the display unit. FIG. 8 shows a screen displayed on the terminal 100. For example, curry, simmered meat and potatoes, and stew are displayed as cooking recipe candidates. The user looking at the cooking recipe candidate displayed on the screen uses the user control unit to select a recipe of the dish to cook. The terminal 100 transmits information on the cooking recipe selected to the information processing apparatus 400. The recipe acquisition unit 460 of the information processing apparatus 400 acquires the information on the cooking recipe from the terminal 100 via the network 300 and the communication unit 410. The information on the cooking recipe may be information on one cooking recipe or information on multiple cooking recipes. The recipe acquisition unit 460 outputs the information on the cooking recipe to the operation block processing unit 462.

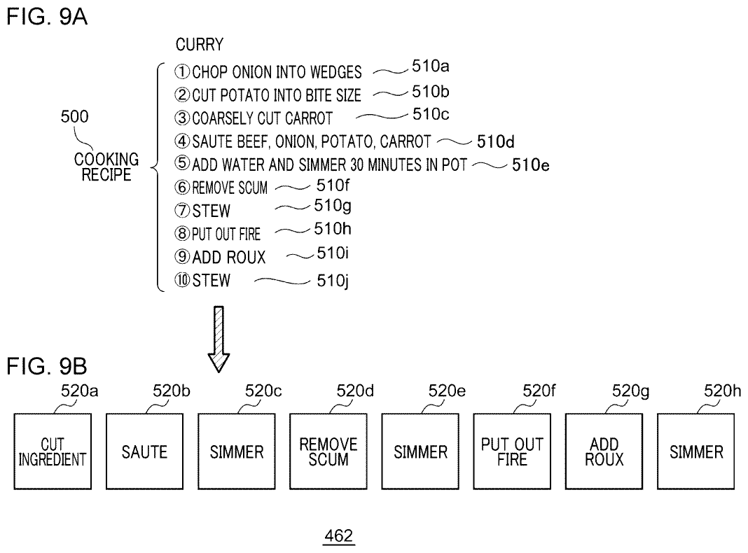

The operation block processing unit 462 receives the information on the cooking recipe from the recipe acquisition unit 460. By way of one example, curry is indicated in the information on the cooking recipe. FIGS. 9A-9B show an overview of a process executed by the operation block processing unit 462. FIG. 9A shows a cooking recipe 500 for curry received by the operation block processing unit 462. In the cooking recipe 500, a first cooking step 510a to a tenth cooking step 510h are arranged in order. The first cooking step 510a to the tenth cooking step 510h are collectively referred to as the cooking step 510. The cooking step 510 shows an operation at one stage in cooking performed in multiple stages. For example, the first cooking step 510a indicates “chop onion into wedges”.

The operation block processing unit 462 interprets the detail of each cooking step 510 of the cooking recipe 500. For example, the operation block processing unit 462 performs morphological analysis as an example of interpretation of the detail. As a result, the operation block processing unit 462 extracts information on the operation related to cooking from each of the plurality of cooking steps 510. The subject of the “operation related to cooking” may be the user (human being) or an automatic cooking appliance (cooking utensil) such as an auto cooker. For example, interpretation is made on a level capable of identifying verbs such as “cut (cooking ingredient)”, “simmer”, “grill”, “boil”, and “cool”.

The recipe acquisition unit 460 converts the extracted information on the operation into a block (hereinafter referred to as an “operation block”) indicating an operation related to cooking. FIG. 9B shows a first operation block 520a to an eighth operation block 520h derived from conversion in the recipe acquisition unit 460. The first operation block 520a is a block indicating a “cut ingredient” operation, and the second operation block 520b is a block indicating a “saute” operation. The first cooking step 510a to the third cooking step 510c are converted into the first operation block 520a, and the fourth cooking step 510d is converted into the second operation block 520b. In that process, information other than the operation in the fourth cooking step 510d, i.e., “beef, onion, potato, carrot” is associated with the second operation block 520b. The same applies to the operation block 520 other than the second operation block 520b. Further, the first operation block 520a to the eighth operation block 520h are collectively referred to as the operation block 520. Reference is made back to FIG. 6.

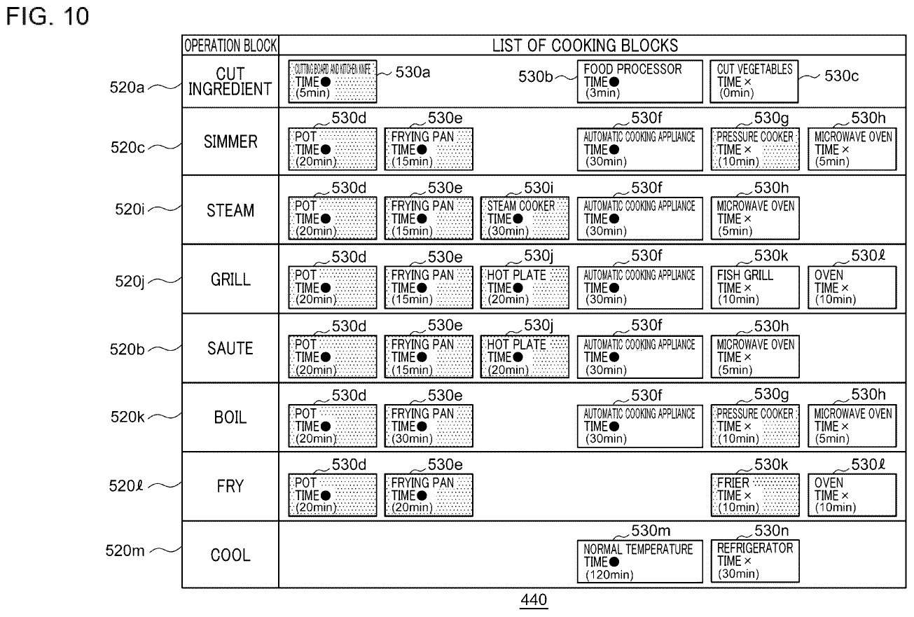

The cooking step storage unit 440 stores correspondence between each of a plurality of operation blocks 520 and one or more blocks (hereinafter referred to as “cooking blocks”). The cooking block is a block indicating the detail of cooking for realizing the operation block 520. The cooking block may be the functional block 1110 described above. FIG. 10 shows a data structure of a database stored in the cooking step storage unit 440. A ninth operation block 520i to a thirteenth operation block 520m included in the database are also collectively referred to as the operation block 520. The database also includes a first cooking block 530a to a fourteenth cooking block 530n, collectively referred to as the cooking block 530. The database may also include the operation block 520 and the cooking block 530 other than those in FIG. 10.

The database shows one or more cooking blocks 530 associated with each operation block 520. For example, the first cooking block 530a to the third cooking block 530c are associated with the first operation block 520a. This indicates that the first operation block 520a is executed by executing one of the first cooking block 530a to the third cooking block 530c. The same applies to other operation blocks 520. Further, this database is common to all cooking recipes 500 and all users.

Each cooking block 530 includes the following information. The first information is information on the utensil or the ingredient to be used to execute the cooking block 530. The ingredient refers to a special ingredient such as cut vegetables. This corresponds, for example, to “cutting board & kitchen knife” in the first cooking block 530a, to the “food processor” in the second cooking block 530b, and to the “cut vegetables” in the third cooking block 530c.

The second information is information indicating whether labor is required to execute the cooking block 530. That labor is required means that the user cannot leave the place and has to see that the dish does not burn, etc. This corresponds to “first information” indicating the degree of involvement of the user in cooking corresponding to the cooking block 530. Further, that labor is not required means that the user may simply have to put the ingredient in the cooking utensil to let the cooking utensil, etc. to take care of the rest and leave it unattended. This corresponds to “second information” indicating that involvement of the user required for cooking corresponding to the cooking block 530 is less than the degree of involvement in the first information. The cooking block 530 such as the first cooking block 530a indicated by a dot includes the first information, and the cooking block 530 such as the second cooking block 530b indicated in white includes the second information.

The third information is information on the cooking time corresponding to the cooking block 530. The cooking time may be indicated by a specific numerical value in a format such as X minutes or may be indicated by information for scoring the time required. The cooking time is, for example, indicated as “5 min” in the first cooking block 530a, “3 min” in the second cooking block 530b, and “0 min” in the third cooking block 530c. Reference is made back to FIG. 6.

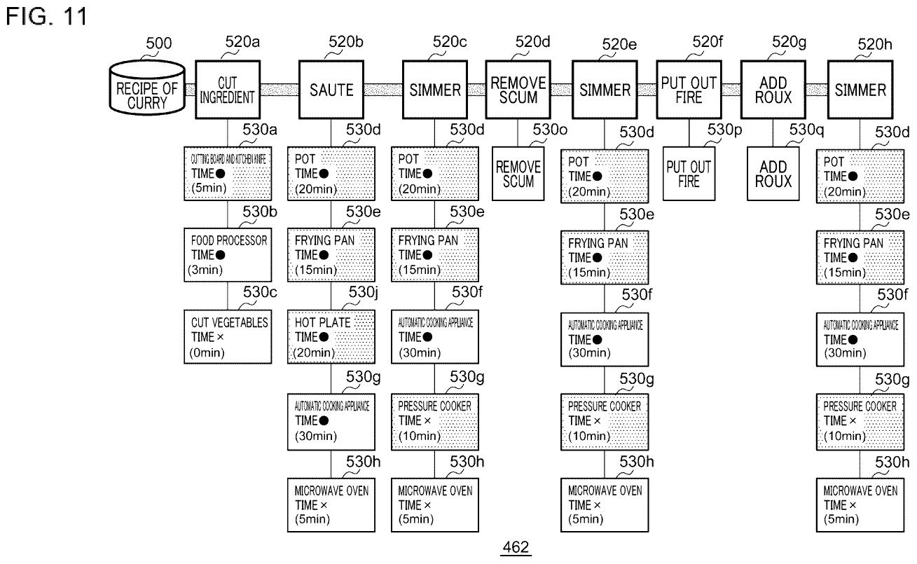

The operation block processing unit 462 acquires one or more cooking blocks 530 corresponding to each of the plurality of operation blocks 520 included in the cooking recipe 500 from the database stored in the cooking step storage unit 440. FIG. 11 shows an overview of another process executed by the operation block processing unit 462. The first operation block 520a to the eighth operation block 520h converted from the plurality of cooking steps 510 included in the cooking recipe 500 are arranged in order. The operation block processing unit 462 acquires the first cooking block 530a to the third cooking block 530c corresponding to the first operation block 520a by referring to the database stored in the cooking step storage unit 440. The operation block processing unit 462 associates the first cooking block 530a to the third cooking block 530c acquired with the first operation block 520a.

The operation block processing unit 462 executes the same process for each of the second operation block 520b to the eighth cooking block 530h. That is, the operation block processing unit 462 associates one or more cooking blocks 530 with each of the plurality of operation blocks 520. Hereinafter, as shown in FIG. 11, one or more cooking blocks 530 associated with each of the plurality of operation blocks 520 may be referred to as “candidate data”. Reference is made back to FIG. 6.

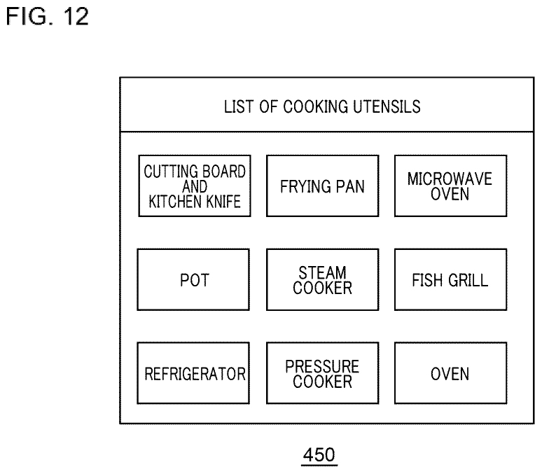

The cooking utensil storage unit 450 stores information on cooking utensils owned at the user's residence. FIG. 12 shows a data structure of a database stored in the cooking utensil storage unit 450. In the database, cooking utensils such as “cutting board & kitchen knife” are indicated. Further, the database may include information on ingredients such as “cut vegetables”. Information on cooking utensils and ingredients included in the database is acquired by sensor information or inputs as in the recipe acquisition unit 460. Further, such databases vary from residence to residence. Reference is made back to FIG. 6. The utensil/ingredient acquisition unit 464 acquires the information included in the database stored in the cooking utensil storage unit 450, i.e., the information on the utensils or ingredients available to the user.

The cooking block selection processing unit 466 selects the cooking block 530 that uses the utensil or the ingredient available to the user from the candidate data, based on the information on the utensils or ingredients available to the user acquired in the utensil/ingredient acquisition unit 464 and the information on the utensils or ingredients to be used to execute each cooking block 530. Hereinafter, candidate data in which the cooking block 530 that uses the utensil or the ingredient available to the user is selected is also referred to as “candidate data”.

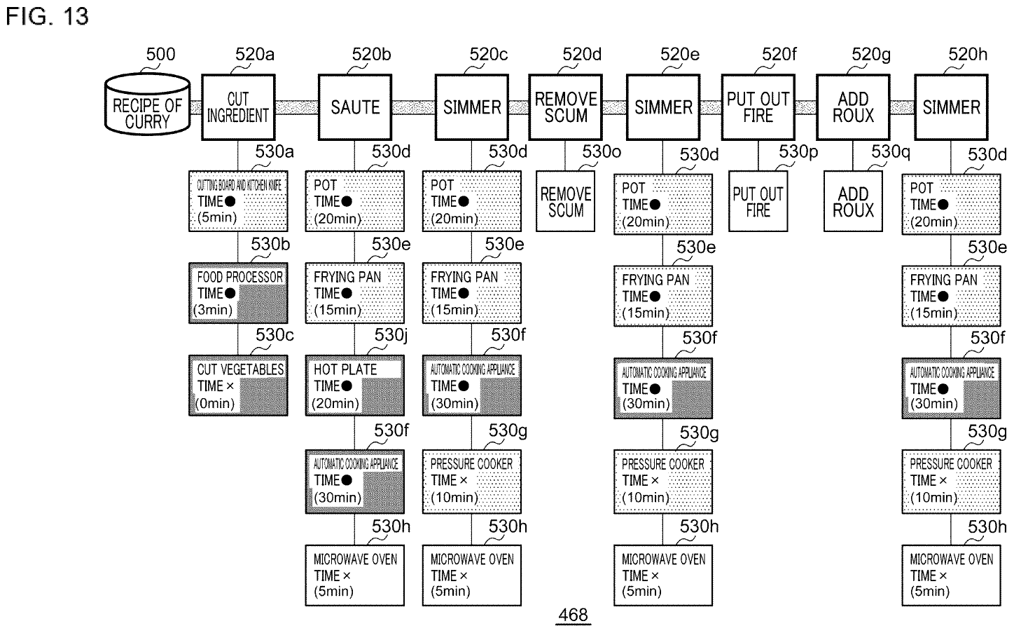

FIG. 13 shows an overview of a process executed by the cooking block selection processing unit 466. As described above, the first cooking block 530a to the third cooking block 530c are associated with the first operation block 520a. Further, the “cutting board & kitchen knife” is used in the first cooking block 530a, the “food processor” is used in the second cooking block 530b, and the “cut vegetable” are used in the third cooking block 530c. On the other hand, the information acquired by the utensil/ingredient acquisition unit 464 includes the “cutting board & kitchen knife” but does not include the “food processor” and the “cut vegetables”.

The cooking block selection processing unit 466 selects the first cooking block 530a that uses the “cutting board & kitchen knife” available to the user, from the first cooking block 530a to the third cooking block 530c associated with the first operation block 520a. That is, the second cooking block 530b and the third cooking block 530c that use the “food processor” and the “cut vegetables” not available to the user are excluded. In FIG. 13, the second cooking block 530b and third cooking block 530c excluded are shown in gray. The cooking block selection processing unit 466 executes the same process for other operation blocks 520. In the second operation block 520b, for example, the fourth cooking block 530d, the fifth cooking block 530e, and the eighth cooking block 530h are selected. Reference is made back to FIG. 6.

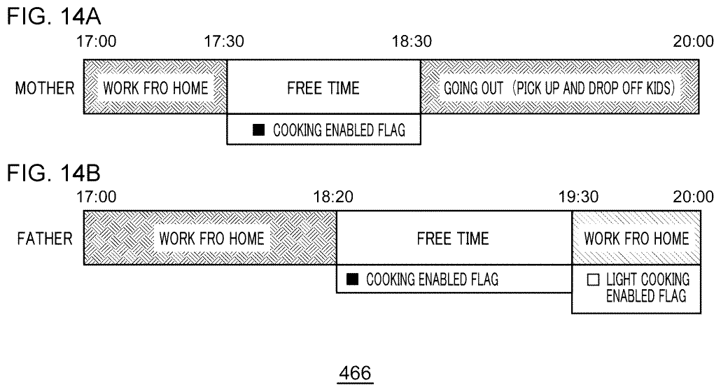

The situation acquisition unit 468 acquires the situation information from the terminal 100 via the communication unit 410 and the network 300. FIGS. 14A-14B show schedules shown in the situation information acquired by the situation acquisition unit 468. FIG. 14A shows an example of a weekday schedule of a user (mother), and FIG. 14B shows an example of a weekday schedule of a user (father).

Two flags, a “cooking enabled flag” and a “light cooking enabled flag”, are entered by the user in the schedule. The cooking enabled flag is set for the time when the user's hands are completely free and cooking steps that require labor can also be performed. This is a flag indicating that the user can execute the cooking blocks 530 of the first information and the second information. On the other hand, the light cooking enabled flag is set for the time when the user cannot be in the kitchen all the time but can perform light cooking actions such as turning off the heat or transferring the ingredient from a frying pan to a pot. For example, the time when the user is working from home, is working but not attending a meeting, is attending a meeting but is not giving any presentation, is at home but has to take care of kids at the same time, etc. meets this criterion. This is a flag indicating that the user can execute the cooking block 530 of the second information but cannot execute the cooking block 530 of the first information. In the case the cooking enabled flag is referred to as the “first flag”, the light cooking enabled flag is called the “second flag”. The time when neither the “cooking enabled flag” nor the “light cooking enabled flag” are assigned indicates the time when the user cannot cook at all, such as when the user is giving a presentation at a meeting while working from home or is going out.

By using the “cooking enabled flag” and the “light cooking enabled flag”, the schedule will include information on the time available to the user for cooking. The schedule shown in FIG. 14A includes “free time” from 17:30 to 18:30 as information on the time available to the user (mother) for cooking. Further, the schedule shown in FIG. 14B includes “free time” from 18:20 to 19:30 and “work from home” from 19:30 to 20:00 as information on the time available to the user (father) for cooking. Reference is made back to FIG. 6. Hereinafter, a description will be given in the order of: (1) when the schedule indicates a cooking enabled flag; (2) when the schedule indicates a light cooking enabled flag; and (3) when the schedule indicates a cooking enabled flag and a light cooking enabled flag.

### (1) When the Schedule Indicates a Cooking Enabled Flag

Here, it is assumed that the schedule of the user (mother) (FIG. 14A) is acquired by the situation acquisition unit 468. The cooking block selection processing unit 466 compares the candidate data with the situation information acquired by the situation acquisition unit 468 and excludes the cooking block 530 not suited to the user's situation from the candidate data. To describe it more specifically, when the situation information includes only the cooking enabled flag, the cooking block selection processing unit 466 selects the cooking block 530 including the first information and excludes the cooking block 530 including the second information. This is because it is possible to put labor to cooking in the time zone indicated by the cooking enabled flag. Hereinafter, candidate data excluding the cooking block 530 not suited to the user's situation is also referred to as “candidate data”.

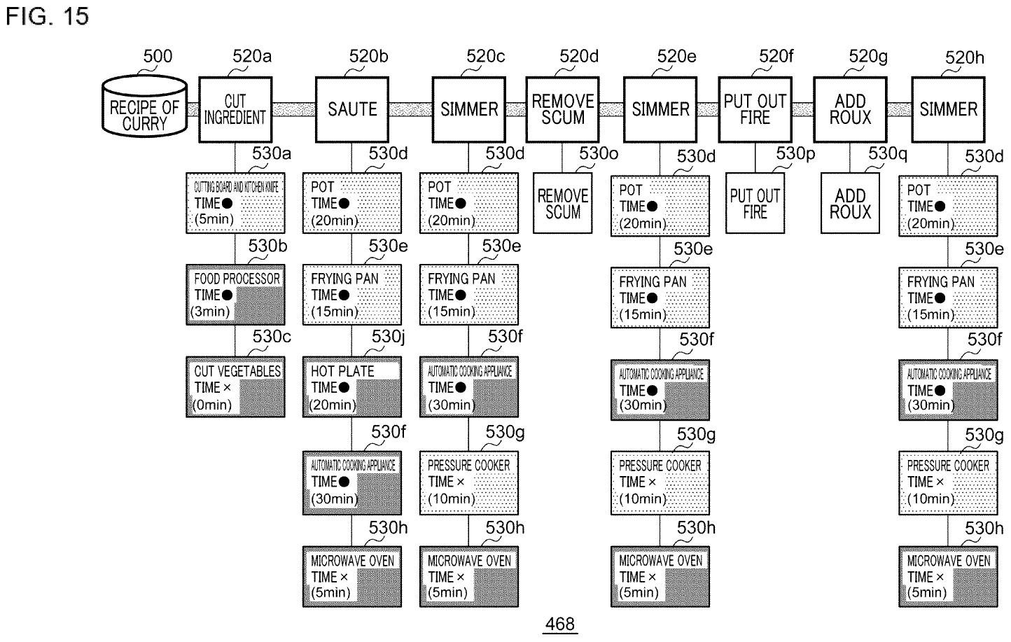

FIG. 15 shows another overview of a process executed by the cooking block selection processing unit 466. The cooking block 530 including the second information, i.e., the cooking block 530 that does not require labor, is the eighth cooking block 530h. Therefore, the cooking block selection processing unit 466 excludes the eighth cooking block 530h from the candidate data. The eighth cooking block 530h excluded is shown in gray. When only one cooking block 530 is associated with the operation block as in the case of the fourth operation block 520d (remove scum), the cooking block selection processing unit 466 does not exclude the one cooking block 530. The same applies to the process following this. Reference is made back to FIG. 6.

The cooking block selection processing unit 466 counts the number of types including the utensils and ingredients to be used, based on the information on the utensils or ingredients to be used to execute the cooking block 530. Further, the cooking block selection processing unit 466 selects the cooking block 530 with a small total number of types. This translates into calculating the total value of the number of types of utensils and the number of types of ingredients used in each cooking block 530 (hereinafter referred to as “type count”) and selecting the block with a small type count. Hereinafter, candidate data in which the cooking block 530 is selected to reduce the number of types may also be referred to as “candidate data”.

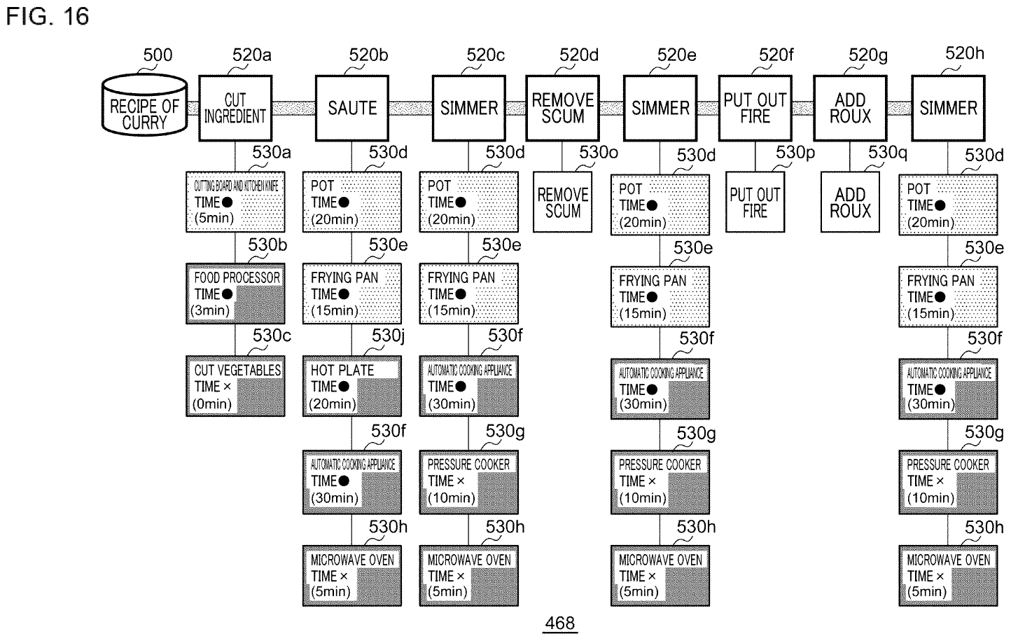

FIG. 16 shows yet another overview of a process executed by the cooking block selection processing unit 466. The fourth cooking block 530d (pot) can be used in the second operation block 520b (saute), the third operation block 520c (simmer), the fifth operation block 520e (simmer), and the eighth operation block 520h (simmer). The fifth cooking block 530e (frying pan) can be used in the second operation block 520b (saute), the third operation block 520c (simmer), the fifth operation block 520e (simmer), and the eighth operation block 520h (simmer).

The seventh cooking block 530g (pressure cooker) can be used in the third operation block 520c (simmer), the fifth operation block 520e (simmer), and the eighth operation block 520h (simmer) but cannot be used in the second operation block 520b (saute). That is, the fourth cooking block 530d (pot) and the fifth cooking block 530e (frying pan) can be used in four operation blocks 520, but the seventh cooking block 530g (pressure cooker) can be used in three operation blocks 520. Therefore, the number of types used will be reduced when the fourth cooking block 530d (pot) and the fifth cooking block 530e (frying pan) are used than when the seventh cooking block 530g (pressure cooker) is used. Therefore, the cooking block selection processing unit 466 calculates the number of operation blocks 520 in which each cooking block 530 is used and determines to exclude the cooking block 530 for which the number of operation blocks 520 is relatively small. The cooking block selection processing unit 466 excludes the seventh cooking block 530g (pressure cooker) from the candidate data. The seventh cooking block 530g (pressure cooker) excluded is shown in gray. In this example, the total number of types will be “3” when the utensils used in each operation block 520s are in the order of “kitchen knife->pot->frying pan->pot”. Reference is made back to FIG. 6.

The cooking block selection processing unit 466 selects one cooking block 530 for each of the plurality of operation blocks 520 arranged in the candidate data and generates a sequence by combining the cooking blocks 530 selected. Further, the cooking block selection processing unit 466 generates another sequence comprised of a different pattern of combining the cooking blocks 530, by changing the selection of the cooking block 530. The cooking block selection processing unit 466 generates a plurality of sequences from the cooking block 530 remaining in the candidate data by repeatedly executing such a process. The sequence may be the functional block sequence 1120 described above.

The cooking block selection processing unit 466 calculates the cooking time of each sequence by integrating the cooking time of the cooking blocks 530 in each sequence. Further, the cooking block selection processing unit 466 calculates a difference between the calculated cooking time and the time available to the user for cooking. The cooking block selection processing unit 466 selects a sequence that results in a small calculated difference. Thereby, one cooking block 530 is selected for one operation block 520.

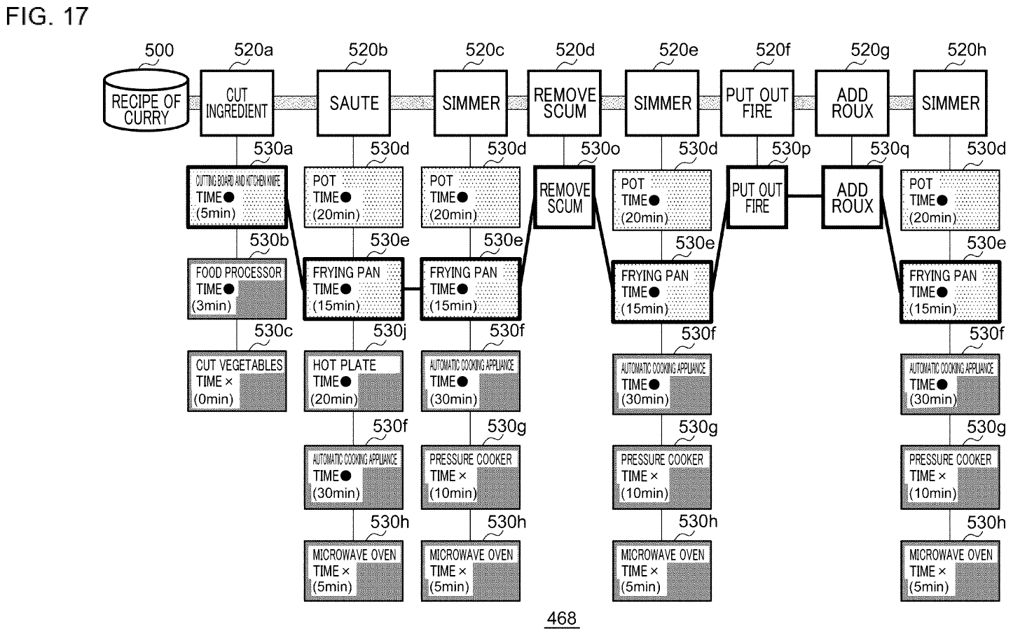

FIG. 17 shows yet another overview of a process executed by the cooking block selection processing unit 466. According to the selection made so far in the cooking block selection processing unit 466, a sequence (hereinafter referred to as the “first sequence”) is created in which the first cooking block 530a, the two fourth cooking blocks 530d, the fifteenth cooking block 530o, the fourth cooking block 530d, the sixteenth cooking block 530p, the seventeenth cooking block 530q, and the fourth cooking block 530d are arranged in the order. Further, a sequence (hereinafter referred to as “second sequence”) is also created in which the first cooking block 530a, the two fifth cooking blocks 530e, the fifteenth cooking block 530o, the fifth cooking block 530e, the sixteenth cooking block 530p, the seventeenth cooking block 530q, and the fifth cooking block 530e are arranged in order.

The cooking time of the first sequence is 1 hour 25 minutes, and the cooking time of the second sequence is 1 hour and 5 minutes. Further, the time available to the user (mother) for cooking is 1 hour. Since the cooking time of the second sequence is closer to the time available to the user (mother) for cooking than the cooking time of the first sequence, the cooking block selection processing unit 466 selects the second sequence. That is, the cooking block selection processing unit 466 selects the first cooking block 530a for the first operation block 520a and selects the fifth cooking block 530e for each of the second operation block 520b, the third operation block 520c, the fifth operation block 520e, and the eighth operation block 520h. Further, the cooking block selection processing unit 466 selects the fifteenth cooking block 530o for the fourth operation block 520d, selects the sixteenth cooking block 530p for the sixth operation block 520f, and selects the seventeenth cooking block 530q for the seventh operation block 520g. Thus, the cooking block selection processing unit 466 selects, in each of the plurality of operation blocks 520, the cooking block 530 suited to the user's situation from one or more cooking blocks 530. Reference is made back to FIG. 6.

The cooking program creation processing unit 470 creates a cooking program by combining the cooking blocks 530 selected in each of the plurality of operation blocks 520. This corresponds to combining the cooking block 530 selected by the cooking block selection processing unit 466 with each operation block 520. The cooking program is a new cooking recipe in which the cooking block 530 is adjusted according to the user's situation.

The output unit 472 outputs a cooking program created by the cooking program creation processing unit 470 to the terminal 100 via the communication unit 410 and the network 300. The terminal 100 receives the cooking program. The terminal 100 is an apparatus capable of displaying the cooking program created and displays the cooking program on the display unit.

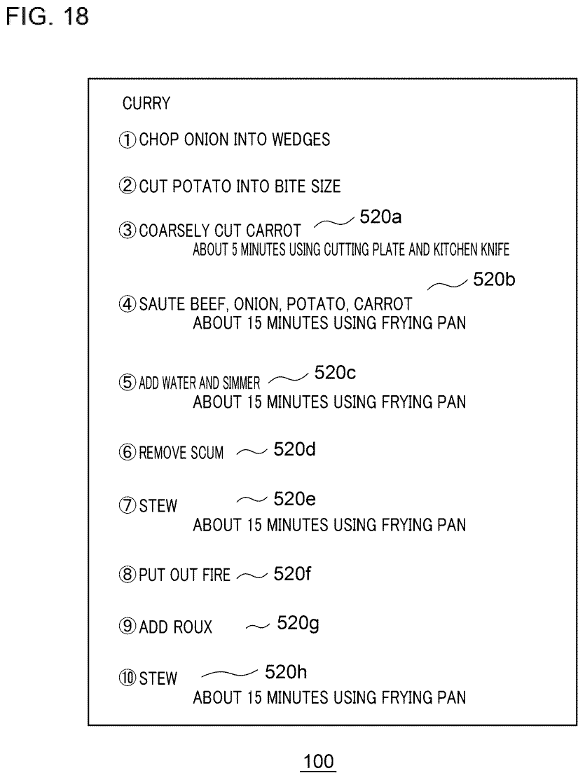

FIG. 18 shows a screen displayed on the terminal 100. The plurality of operation blocks 520 included in the cooking program are shown in the same manner as the plurality of cooking steps 510 included in the cooking recipe 500 shown in FIG. 9A. The detail of the corresponding cooking block 530 is added to each operation block 520. In the second operation block 520b, for example, information “about 15 minutes using frying pan” of the fifth cooking block 530e is added to “saute beef, onion, potato, carrot”. Further, in the third operation block 520c, information “about 15 minutes using frying pan” of the fifth cooking block 530e is added to “add water and simmer”.

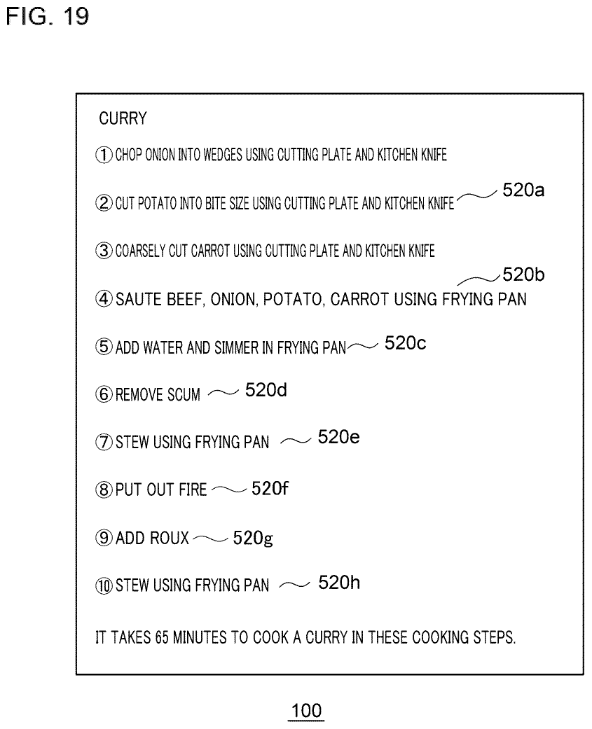

FIG. 19 shows another screen displayed on the terminal 100. As in FIG. 18, the plurality of operation blocks 520 included in the cooking program are shown in the same manner as the plurality of cooking steps 510 included in the cooking recipe 500 shown in FIG. 9A. The utensil used in the corresponding cooking block 530 is added to each operation block 520. In the second operation block 520b, for example, information “in frying pan” of the fifth cooking block 530e is added to “saute beef, onion, potato, carrot”. Further, in the third operation block 520c, information “in frying pan” of the fifth cooking block 530e is added to “add water and simmer”. Further, the cooking time calculated by the cooking block selection processing unit 466, i.e., the time expected to be consumed by the entire cooking may be displayed like “It takes 65 minutes to cook a curry in these cooking step” along with the display of the cooking program.

A button indicating “view other cooking steps” may be displayed on such a screen. When the user selects “view other cooking steps” using the user control unit of the terminal 100, the terminal 100 transmits a signal (hereinafter referred to as a “request signal”) for requesting the information processing apparatus 400 to provide other cooking programs in which the cooking block 530 has been changed. When the communication unit 410 of the information processing apparatus 400 receives the request signal, the cooking block selection processing unit 466 newly selects the first sequence, which was excluded when the second sequence was selected. The cooking program creation processing unit 470 creates a new cooking program reflecting the plurality of cooking blocks 530 included in the first sequence. The output unit 472 outputs the new cooking program created by the cooking program creation processing unit 470 to the terminal 100, which is an example of an external apparatus, via the communication unit 410 and the network 300.

When the terminal 100 receives the new cooking program, the terminal 100 displays a screen showing the new cooking program on the display unit. In the screen showing the new cooking program, “frying pan” in FIGS. 18 and 19 is replaced by “pot”. Further, “15 minutes” in FIG. 18 is replaced by “20 minutes”. In that case, a message such as “Cooking in a pot will extend the cooking time by X minutes” may be displayed.

The cooking block 530 has been described so far as including the cooking time. For example, the fifth cooking block 530e includes “15 min”, which is the cooking time in a frying pan. In the case information on the cooking time is not included in the cooking block 530, however, the processing unit 420 of the information processing apparatus 400 may execute the following process. Assuming that the utensil and the time such as “boil in pot for 30 minutes” is described in the cooking step 510 in the original cooking recipe 500, and a change is made to the fifth cooking block 530e that uses a frying pan, the processing unit 420 calculates the value X of the amount of heat J required for simmering in a pot for 30 minutes and how many minutes it takes to reach the value X with the frying pan. The cooking step storage unit 440 creates a cooking program by replacing the utensil and the time.

### (2) When the Schedule Indicates a Light Cooking Enabled Flag

This corresponds to the case where the light cooking enabled flag is included instead of the cooking enabled flag in the schedule (FIG. 14A) of the user (mother) acquired by the situation acquisition unit 468. The cooking block selection processing unit 466 compares the candidate data with the situation information acquired by the situation acquisition unit 468 and excludes the cooking block 530 not suited to the user's situation from the candidate data. When the situation information includes only the light cooking enabled flag, the cooking block selection processing unit 466 selects the cooking block 530 including the second information and excludes the cooking block 530 including the first information. Since the subsequent process is the same as above, a description thereof is omitted here.

### (3) When the Schedule Indicates a Cooking Enabled Flag and a Light Cooking Enabled Flag

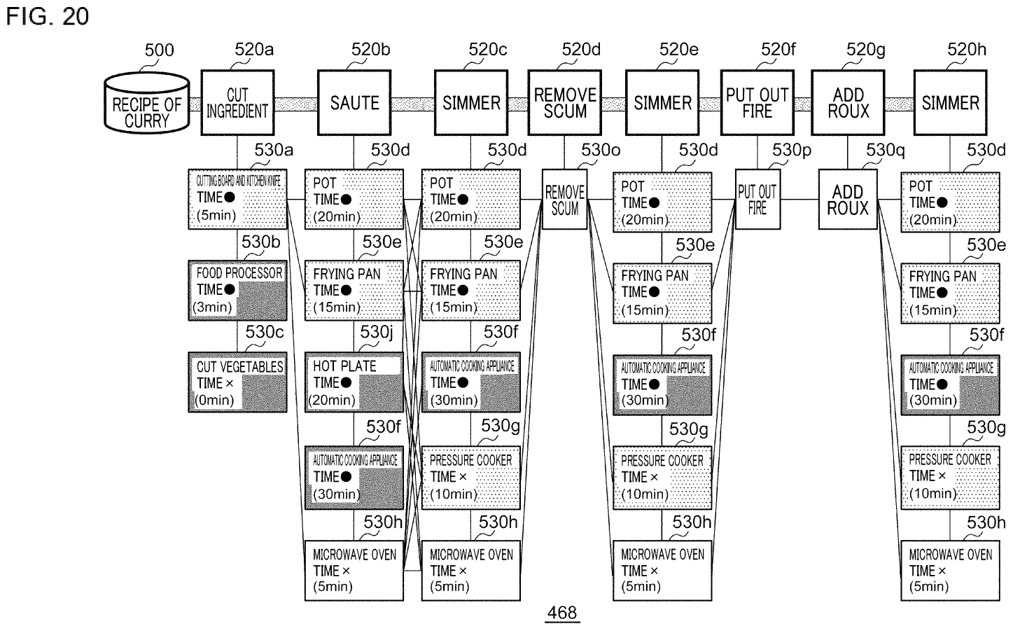

It is assumed here that the schedule of the user (father) (FIG. 14B) is acquired by the situation acquisition unit 468. The cooking block selection processing unit 466 compares the candidate data with the situation information acquired by the situation acquisition unit 468 and excludes the cooking block 530 not suited to the user's situation from the candidate data. To illustrate this process specifically, FIGS. 20 to 22 are used.

FIG. 20 shows yet another overview of a process executed by the cooking block selection processing unit 466. The cooking block selection processing unit 466 connects all of the cooking block 530s, of the candidate data, that use the utensil or the ingredient available to the user. As a result, a sequence is created in which the first cooking block 530a, the two fourth cooking blocks 530d, the fifteenth cooking block 530o, the fourth cooking block 530d, the sixteenth cooking block 530p, the seventeenth cooking block 530q, and the fourth cooking block 530d are arranged in order.

Further, a sequence is also created in which the first cooking block 530a, the two fifth cooking blocks 530e, the fifteenth cooking block 530o, the fifth cooking block 530e, the sixteenth cooking block 530p, the seventeenth cooking block 530q, and the fifth cooking block 530e are arranged in order. A sequence is also created in which the first cooking block 530a, the two eighth cooking blocks 530h, the fifteenth cooking block 530o, the eighth cooking block 530h, the sixteenth cooking block 530p, the seventeenth cooking block 530q, and the eighth cooking block 530h are arranged in order. Further, a sequence such as that comprised of a mixture of the fourth cooking block 530d, the fifth cooking block 530e, and the eighth cooking block 530h is also created. In this way, a plurality of types of sequences are formed.

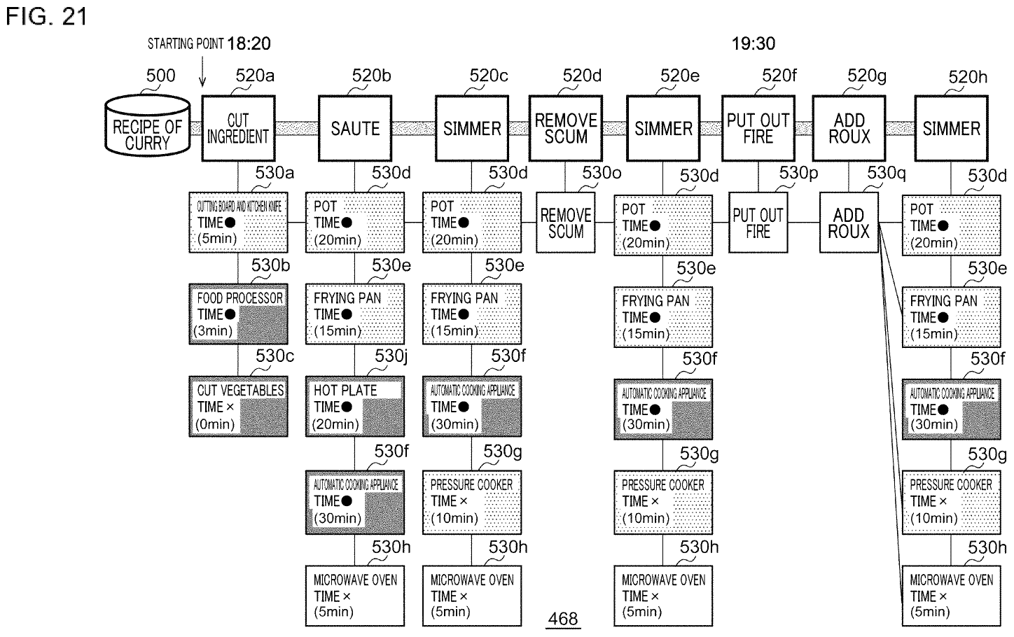

FIG. 21 shows yet another overview of a process executed by the cooking block selection processing unit 466. The figure shows some of a plurality of sequences created in FIG. 20. Four types of sequences are shown here. The first cooking block 530a, the two fourth cooking blocks 530d, the fifteenth cooking block 530o, the fourth cooking block 530d, the sixteenth cooking block 530p, and the seventeenth cooking block 530q are common to these sequences. A sequence proceeding from the seventeenth cooking block 530q to the fourth cooking block 530d, a sequence proceeding from the seventeenth cooking block 530q to the fifth cooking block 530e, a sequence proceeding from the seventeenth cooking block 530q to the seventh cooking block 530g, and a sequence proceeding from the seventeenth cooking block 530q to the eighth cooking block 530h are created.

The cooking block selection processing unit 466 detects a point of time “19:30” when switching between the cooking enabled flag and the light cooking enabled flag takes place (hereinafter referred to as “switching timing”) by adding the cooking time of the cooking block 530 sequentially from the starting point “18:20” of the sequence. In this example, the timing of the sixth operation block 520f, i.e., the sixteenth cooking block 530p, is detected as the switching timing. Further, the cooking block selection processing unit 466 identifies the period of the light cooking enabled flag, based on the switching timing. Here, the period after the switching timing is identified as the period of the light cooking possible flag. These steps are performed for each sequence. In the four types of sequences illustrated, the switching timing and the period of the light cooking enabled flag are common to the sequences. However, there are also sequences that differ in the switching timing and the period of the light cooking enabled flag.

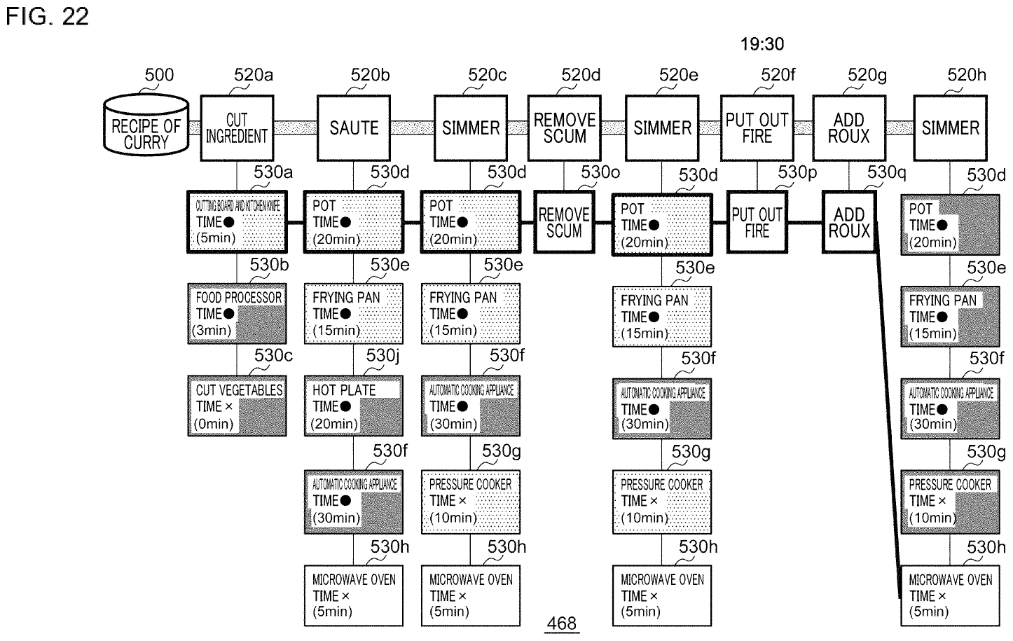

FIG. 22 shows yet another overview of a process executed by the cooking block selection processing unit 466. The figure shows the process following FIG. 21. The cooking block selection processing unit 466 selects the cooking block 530 including the second information during the period of the light cooking enabled flag, i.e., the cooking block 530 that does not require labor. In the case of FIG. 22, the eighth cooking block 530h is selected. Since the subsequent process is the same as above, a description thereof is omitted here.

The features are implemented in hardware such as a CPU (Central Processing Unit), a memory, or other LSI's (Large Scale Integration), of any computer and in software such as a program loaded into a memory. The figure depicts functional blocks implemented by the cooperation of these elements. Therefore, it will be understood by those skilled in the art that these functional blocks may be implemented in a variety of manners by hardware only or by a combination of hardware and software.

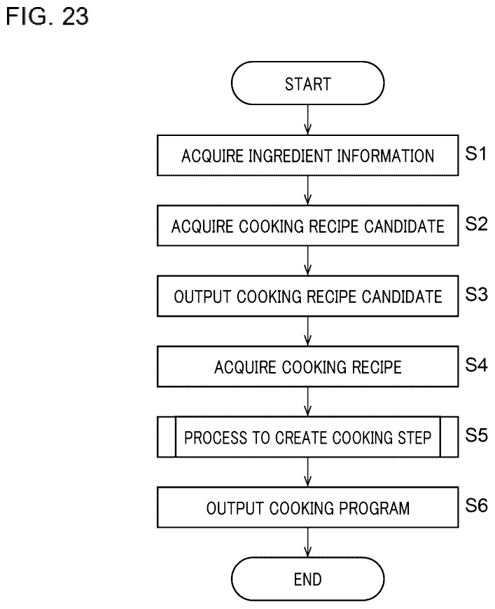

The operation of the information processing system 1000 according to the above configuration will be described. FIG. 23 is a flowchart showing a sequence of steps to output a cooking program executed by the information processing apparatus 400. When the recipe acquisition unit 460 acquires the cooking ingredient information (S1), the recipe acquisition unit 460 acquires a cooking recipe candidate (S2) by referring to the cooking recipe storage unit 430 (S2). The recipe acquisition unit 460 outputs the cooking recipe candidate to the terminal 100 (S3) and acquires the selected cooking recipe 500 from the terminal 100 (S4). The operation block processing unit 462 through the cooking program creation processing unit 470 execute the process to create a cooking step (S5). The output unit 472 outputs the cooking program to the terminal 100 (S6).

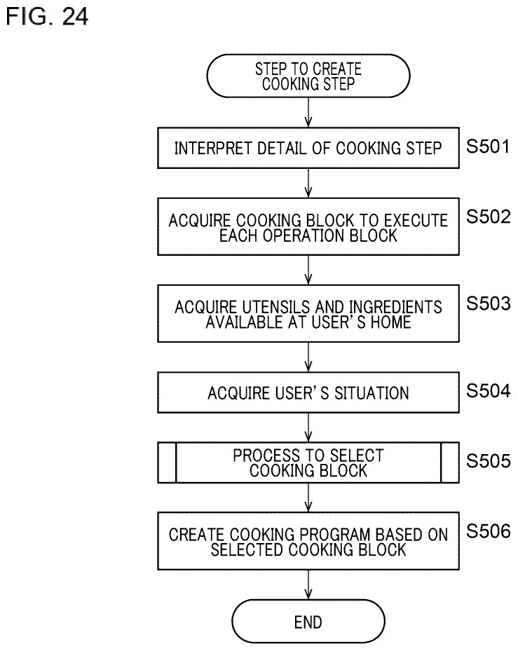

FIG. 24 is a flowchart showing a sequence of steps to create a cooking step executed by the information processing apparatus 400. This corresponds to step S5 of FIG. 23. The operation block processing unit 462 interprets the detail of the cooking step 510 of the cooking recipe 500 (S501) and replaces the cooking step 510 by the operation block 520. The operation block processing unit 462 acquires the cooking block 530 for executing each operation block 520 (S502). The utensil/ingredient acquisition unit 464 acquires utensils/ingredients available at the user's home (S503). The situation acquisition unit 468 acquires the user's situation (S504). The cooking block selection processing unit 466 executes the process to select the cooking block 530 (S505). The cooking program creation processing unit 470 creates a cooking program based on the cooking block 530 selected (S506).

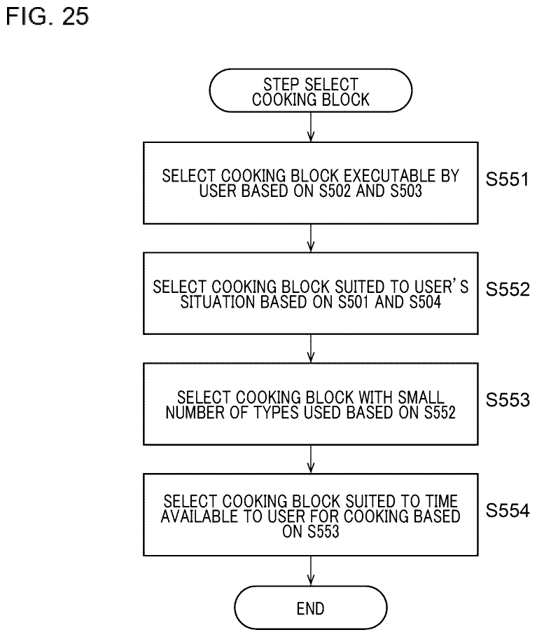

FIG. 25 is a flowchart showing a sequence of steps to select a cooking block executed by the information processing apparatus 400. This corresponds to step S505 in FIG. 24. The cooking block selection processing unit 466 selects the cooking block 530 executable by the user, based on S502 and S503 (S551). The cooking block selection processing unit 466 selects the cooking block 530 suited to the user's situation, based on S551 and S504 (S552). The cooking block selection processing unit 466 selects the cooking block 530 with a small number of types used, based on S552 (S553). The cooking block selection processing unit 466 selects the cooking block 530 suited to the time available to the user for cooking, based on S553 (S554).

According to this embodiment, one or more cooking blocks 530 are associated with each of the plurality of operation blocks 520 included in the cooking recipe 500, and then a cooking program is created by selecting the cooking block 530 suited to the user's situation. It is therefore possible to provide a cooking recipe suited to the user's situation. Further, information on the operation related to cooking is extracted from each of the plurality of cooking steps 510 included in the cooking recipe 500 and the extracted information on the operation is converted into the operation block 520 so that the operation block 520 corresponding to the cooking recipe 500 can be obtained. Further, the correspondence between the operation block 520 and the one or more cooking blocks 530 is stored for each operation block 520, and one or more cooking blocks 530 corresponding to the operation block 520 are acquired based on the correspondence. It is therefore possible to acquire the cooking block 530 easily. Further, the cooking block 530 is selected based on the information on the utensils or ingredients available to the user and the information on the utensils or ingredients to be used to execute the cooking block 530. It is therefore possible to select the cooking block 530 that uses the utensils or ingredients available to the user.

Further, each cooking block 530 includes one of the first information indicating the degree of involvement of the user in cooking corresponding to the cooking block 530 and the second information indicating that the user's involvement required for cooking corresponding to the cooking block 530 is smaller than the degree of involvement in the first information. It is therefore possible to define the degree of labor required for cooking corresponding to the cooking block 530. Further, the situation information includes at least one of: the cooking enabled flag indicating that the user can execute the cooking block 530 of the first information and the second information; and the light cooking enabled flag indicating that the user can execute the cooking block 530 of the second information but cannot execute the cooking block of the first information. It is therefore possible to present the degree of labor that the user can put into cooking.

Further, the cooking block 530 is selected based on the degree of labor defined in the cooking block 530 and the degree of labor that the user can put into cooking. It is therefore possible to select the cooking block 530 corresponding to the degree of labor that the user can put into cooking. Further, the cooking block 530 is selected to reduce the number of types used, based on the information on the utensils or ingredients available to the user and the information on the utensils or ingredients to be used to execute the cooking block 530 so that user convenience can be improved. Further, the cooking block 530 is selected so that the cooking time that results when a plurality of cooking blocks 530 are combined is close to the time available to the user for cooking so that it is ensured that the cooking time is suited to the user's situation. Further, the cooking program created is output to the terminal 100 so that the cooking program can be checked by the user.

### Variation 1

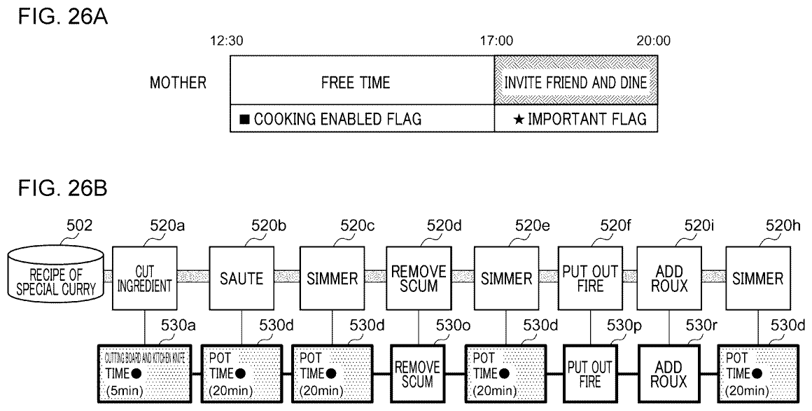

FIGS. 26A-26B show an overview of a process according to variation 1. FIG. 26A shows an example of a user's schedule on a certain day when there is a special appointment such as a party. When the user wants to cook an elaborate dish for the special appointment, an “important flag” is assigned to the schedule. When the situation acquisition unit 468 of the information processing apparatus 400 acquires situation information including the schedule having the “important flag” assigned thereto, the cooking block selection processing unit 466 selects, as the cooking block 530 suited to the user's situation, the cooking block 530 that requires cooking time and labor, based on the “important flag”. As a result, a cooking program based on a cooking recipe 502 for curry as shown in FIG. 26B is created.

Further, even if the “important flag” is not assigned to the schedule included in the situation information, a special cooking ingredient (e.g., “spice”) may be registered in advance. When the cooking ingredient information acquired by the recipe acquisition unit 460 of the information processing apparatus 400 includes the special cooking ingredient “spice” registered in advance, the cooking block selection processing unit 466 creates a cooking program based on the cooking recipe 502 for curry as shown in FIG. 26B in the same manner as when the “important flag” is assigned.

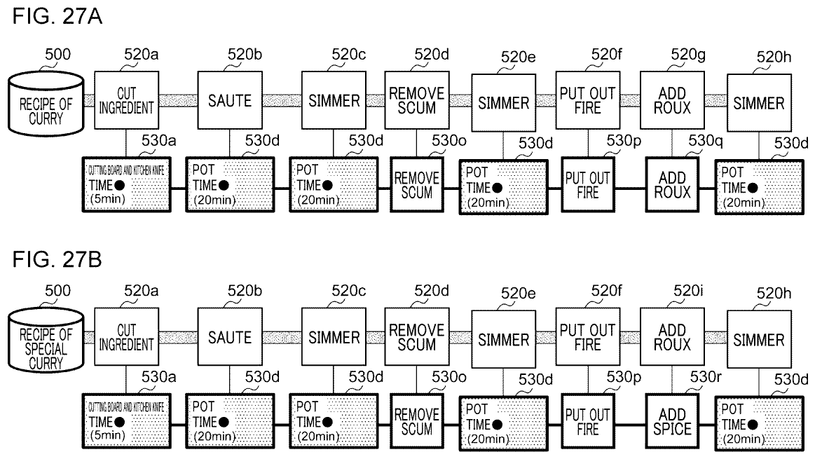

FIGS. 27A-27B show another overview of a process according to variation 1. FIG. 27A shows a cooking program created without changing the cooking recipe 500 for curry, and FIG. 27B shows a cooking program based on the cooking recipe 502 for special curry. Comparing these, the programs differ in “add roux” of the seventh operation block 520g and the seventeenth cooking block 530q in the cooking recipe 500 and in “add spice” of the ninth operation block 520i and the eighteenth cooking block 530r in the cooking recipe 502.

The user seeing the curry cooking program of FIG. 27A displayed on the terminal 100 may enter an instruction to change “add roux” of the seventh operation block 520g and the seventeenth cooking block 530q to “add spice” by using the user control unit of the terminal 100. In that process, a presentation such as “You can make a more authentic curry by changing roux to spice” may be displayed on the terminal 100. The cooking block selection processing unit 466 of the information processing apparatus 400 that has received the instruction changes “add roux” of the seventh operation block 520g and the seventeenth cooking block 530q to “add spice” of the ninth operation block 520i and the eighteenth cooking block 530r. In this case, the ninth operation block 520i and the eighteenth cooking block 530R of “add spice” are stored in advance in the cooking step storage unit 440 as “option blocks” for the seventh operation block 520g and the seventeenth cooking block 530q of “add roux”.

According to this variation, an elaborate cooking program is created by assigning the important flag to the schedule so that a cooking program suited to the user can be provided. Further, an elaborate cooking program is created by changing some operation blocks 520 (cooking blocks 530) of a cooking program for an ordinary dish so that the cooking program can be easily modified.

### Variation 2

The cooking block selection processing unit 466 described so far executes the process of selecting the cooking block 530 according to the number of types and then executes the process of selecting the cooking block 530 according to the cooking time. However, the cooking block selection processing unit 466 may switch the order and may execute the process of selecting the cooking block 530 according to the cooking time and then execute the process of selecting the cooking block 530 according to the number of types.

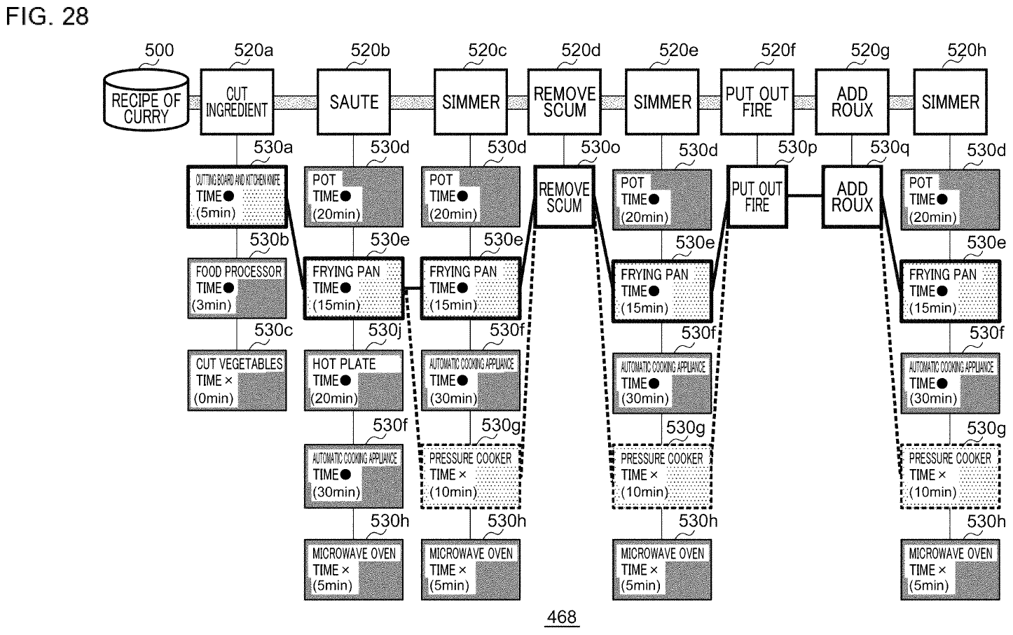

FIG. 28 shows an overview of a process executed by the cooking block selection processing unit 466. This indicates candidate data excluding the cooking blocks 530 not suited to the user's situation. The cooking block selection processing unit 466 generates a plurality of sequences from the cooking block 530 remaining in the candidate data. Further, the cooking block selection processing unit 466 calculates the cooking time of each sequence. Further, the cooking block selection processing unit 466 selects a sequence so that the cooking time of the sequence is close to the time available to the user for cooking.

In this example, a sequence (hereinafter referred to as the “third sequence”) is selected in which the first cooking block 530a, the two fifth cooking blocks 530e, the fifteenth cooking block 530o, the fifth cooking block 530e, the sixteenth cooking block 530p, the seventeenth cooking block 530q, and the fifth cooking block 530e are arranged in order. Further, a sequence (hereinafter referred to as the “fourth sequence”) is selected in which the first cooking block 530a, the fifth cooking block 530e, the seventh cooking block 530g, the fifteenth cooking block 530o, the seventh cooking block 530g, the sixteenth cooking block 530p, the seventeenth cooking block 530q, and the seventh cooking block 530g are arranged in order.

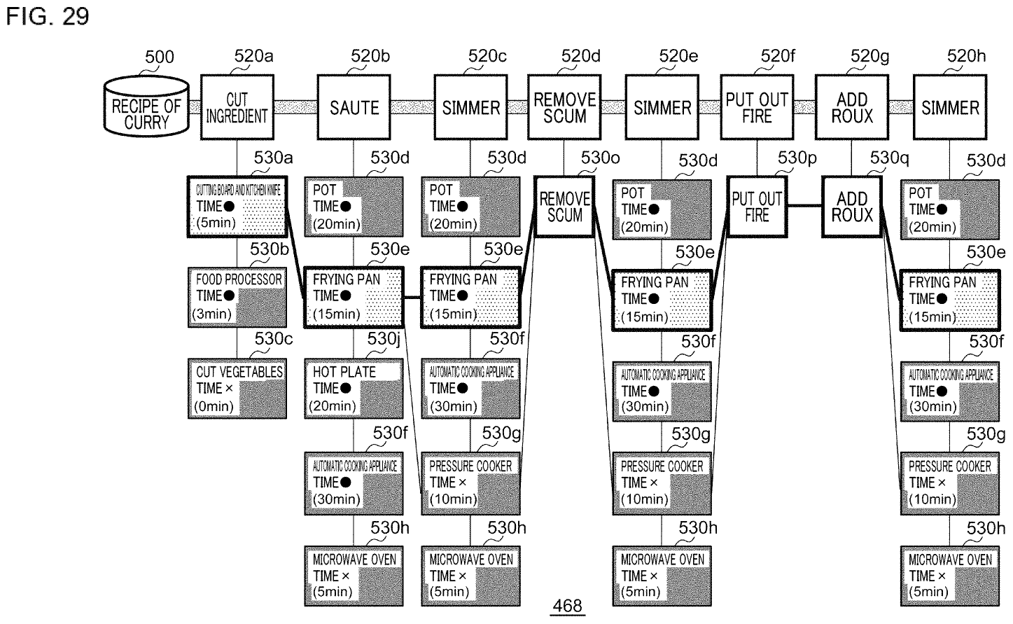

FIG. 29 shows another overview of a process executed by the cooking block selection processing unit 466. The figure shows the process following FIG. 28. The cooking block selection processing unit 466 selects the cooking block 530 from the candidate data so that the number of types used in the candidate data is reduced, based on information on the utensils or ingredients to be used to execute the cooking block 530. The third sequence is selected according to the same process as above.

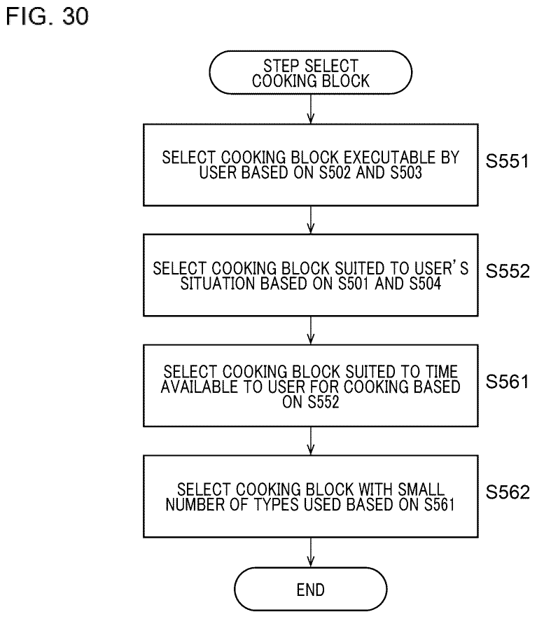

The operation of the information processing system 1000 according to the above configuration will be described. FIG. 30 is a flowchart showing a sequence of steps to select a cooking block executed by the information processing apparatus 400. This corresponds to step S505 in FIG. 24. The cooking block selection processing unit 466 selects the cooking block 530 executable by the user, based on S502 and S503 (S551). The cooking block selection processing unit 466 selects the cooking block 530 suited to the user's situation, based on S551 and S504 (S552). The cooking block selection processing unit 466 selects the cooking block 530 suited to the time available to the user for cooking, based on S552 (S561). The cooking block selection processing unit 466 selects the cooking block 530 with a small number of types used, based on S561 (S562).

According to this variation, the order of selection of the cooking block 530 is switched so that the flexibility of the configuration can be improved.

### Variation 3

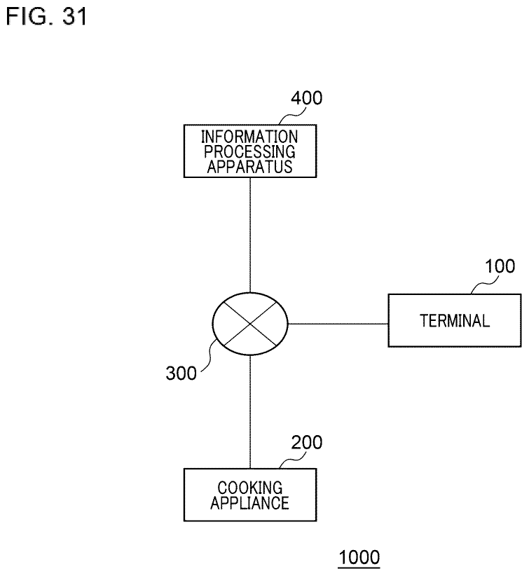

FIG. 31 shows a configuration of the information processing system 1000. As compared to the system of FIG. 5, the information processing system 1000 further includes a cooking appliance 200. The cooking appliance 200 is, for example, a rice cooker, a microwave oven, and an automatic cooking appliance. The cooking appliance 200 may be the appliance 1100 described above. The cooking appliance 200 has a communication function and is connected to the information processing apparatus 400 via the network 300. The output unit 472 of the information processing apparatus 400 transmits the cooking program to the cooking appliance 200 via the communication unit 410 and the network 300. In that process, the cooking program may be converted into a format that can be processed by the cooking appliance 200. When the cooking appliance 200 receives the cooking program, the cooking appliance 200 executes the cooking program.

According to this variation, the cooking program is output to the cooking appliance 200 and the cooking appliance 200 is caused to execute the cooking program so that user convenience can be improved.

### Variation 4

The situation acquisition unit 468 described so far acquires the situation information including the schedule of the user (mother) shown in FIG. 14A or acquires the situation information including the schedule of the user (father) shown in FIG. 14B. In this case, the situation acquisition unit 468 may acquire both schedules.

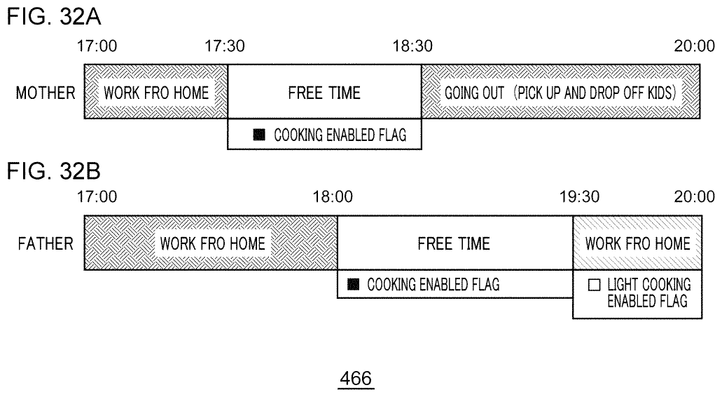

FIGS. 32A-32B show schedules indicated in the situation information acquired by the situation acquisition unit 468. FIG. 32A shows the schedule of the user (mother), where the cooking enabled flag is assigned to the period from 17:30 to 18:30. FIG. 32B shows the schedule of the user (father), where the cooking enabled flag is assigned to the period from 18:00 to 19:30, and the light cooking enabled flag is assigned to the period from 19:30 to 20:00.

When the cooking block selection processing unit 466 of the information processing apparatus 400 receives the situation information from the situation acquisition unit 468, the period of the cooking enabled flag in the schedule of the user (mother) and the period of the cooking enabled flag and the period of the light cooking enabled flag in the schedule of the user (father) are combined. As a result, a period of the cooking enabled flag from 17:30 to 19:30 and the period of the light cooking enabled flag from 19:30 to 20:00 are formed. In the case the period of the cooking enabled flag and the period of the light cooking enabled flag overlap between the schedule of the user (mother) and the schedule of the user (father), the period of the cooking enabled flag may be prioritized. The process following this is the same as the process in the case (3) when the schedule indicates a cooking enabled flag and a light cooking enabled flag so that a description thereof is omitted.

### Embodiment 2

The information processing apparatus 400 in embodiment 1 creates a cooking program for one cooking recipe 500 selected from the cooking recipe candidates. The information processing apparatus 400 in embodiment 2 creates a cooking program for each of the plurality of cooking recipes 500 included in the cooking recipe candidate. Thereby, one cooking program is selected from a plurality of cooking programs.

The recipe acquisition unit 460 of the information processing apparatus 400 acquires the same cooking recipe candidate as above. For example, the cooking recipe candidate includes “simmered meat and potatoes, curry, anhydrous curry”. The operation block processing unit 462 through the cooking program creation processing unit 470 create a cooking program for each of the cooking recipe 500 for simmered meat and potatoes, the cooking recipe 500 for curry, and the cooking recipe 500 for anhydrous curry. The output unit 472 transmits a cooking program for simmered meat and potatoes, a cooking program for curry, and a cooking program for anhydrous curry to the terminal 100 via the communication unit 410 and the network 300. When the terminal 100 receives the cooking program for simmered meat and potatoes, the cooking program for curry, and the cooking program for anhydrous curry, the terminal displays the cooking program for simmered meat and potatoes, the cooking program for curry, and the cooking program for anhydrous curry on a display unit. The user selects one cooking program by checking the cooking program for simmered meat and potatoes, the cooking program for curry, and the cooking program for anhydrous curry displayed.

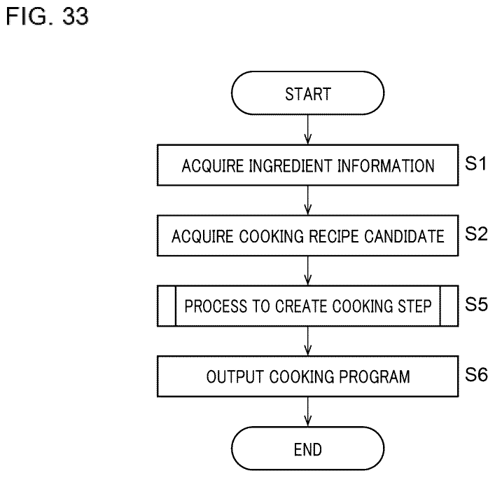

The operation of the information processing system 1000 according to the above configuration will be described. FIG. 33 is a flowchart showing a sequence of steps to output a cooking program executed by the information processing apparatus 400. When the recipe acquisition unit 460 acquires the cooking ingredient information (S1), the recipe acquisition unit 460 acquires the cooking recipe candidate by referring to the cooking recipe storage unit 430 (S2). The operation block processing unit 462 through the cooking program creation processing unit 470 execute the process to create a cooking step (S5). The output unit 472 outputs the cooking program to the terminal 100 (S6).

According to this embodiment, a plurality of cooking programs are created and presented to the user so that it is easy for the user to select a cooking program.

### Embodiment 3

It has been assumed so far that one dish is cooked, and the information processing apparatus 400 creates a cooking program corresponding to one dish. In embodiment 3, a case is assumed in which a plurality of dishes are cooked together.

The recipe acquisition unit 460 of the information processing apparatus 400 has already acquired information on one cooking recipe 500 (e.g., the cooking recipe 500 for curry). The operation block processing unit 462 through the situation acquisition unit 468 create a cooking program for curry based on the cooking recipe 500 for curry. When the user wants to cook another dish such as potato salad as a side dish in this state, the recipe acquisition unit 460 acquires information on another cooking recipe 500 (e.g., the cooking recipe 500 for potato salad) based on the user's instruction. The operation block processing unit 462 through the situation acquisition unit 468 execute the same process as above based on the cooking recipe 500 for potato salad.

It will be noted that the cooking recipe 500 for potato salad includes the operation block 520 to “boil” potatoes. In the database (FIG. 10) stored in the cooking step storage unit 440, the fifth cooking block 530e of “frying pan” is associated with the eleventh operation block 520k corresponding to “boil”. When the fifth cooking block 530e of “frying pan” is used in the cooking program for curry, however, the cooking block selection processing unit 466 excludes, when selecting the cooking block 530 for potato salad, the fifth cooking block 530e of “frying pan” to prevent the fifth cooking block 530e of “frying pan” from being used.

According to this embodiment, it is ensured that the cooking blocks 530 do not overlap when a plurality of cooking programs are created. Therefore, conflict between a plurality of cooking programs as to the utensil can be avoided.

### Embodiment 4

Each cooking block 530 described so far includes three types of information, namely, the information on the utensils or ingredients to be used to execute the cooking block 530, the information indicating whether labor is required to execute the cooking block 530, and the information on the cooking time corresponding to the cooking block 530. Each cooking block 530 according to embodiment 4 includes further information in addition to the three types of information described above. The information processing system 1000 and the information processing apparatus 400 according to embodiment 4 are of the same type as those of FIGS. 5 and 6. In this section, we will focus on the differences from the above.

The user control unit of the terminal 100 of FIG. 5 receives information indicating a request for cooking (hereinafter referred to as “request information”) from the user. The request information includes information on whether the taste of the dish is prioritized and information on whether the appearance of the dish is prioritized. The information included in the request information is not limited thereto. The terminal 100 transmits the request information to the information processing apparatus 400 via the network 300. The request information may be transmitted along with the situation information or may be transmitted separately from the situation information. The information processing apparatus 400 receives the situation information and the request information from the terminal 100 via the network 300.

The database stored in the cooking step storage unit 440 of the information processing apparatus 400 of FIG. 6 includes a plurality of types of cooking blocks 530 as described before. As described above, each cooking block 530 includes the information on the utensils or ingredients to be used to execute the cooking block 530, the information indicating whether labor is required to execute the cooking block 530, and the information on the cooking time corresponding to the cooking block 530. Each cooking block 530 according to this embodiment further includes information indicating whether the user's failures in cooking are few and information indicating whether the appearance of the cooked dish is affected.

In the information indicating whether the user's failures in cooking are few, a case where there are few failures in cooking is indicated by “1”, and a case where there are not a few failures in cooking is indicated by “0”, for example. The information indicating whether the user's failures in cooking are few is predetermined but may be updated each time the user cooks. When the user inputs success or failure information to the terminal 100 after the user finishes cooking, for example, the terminal 100 transmits the information on the cooking program executed and the success or failure information to the information processing apparatus 400. The processing unit 420 of the information processing apparatus 400 identifies one or more cooking blocks 530 included in the cooking program received and manages the number of successes and the number of failures for each cooking block 530. The processing unit 420 calculates the number of successes/(the number of successes+the number of failures) and determines that failures in cooking are few when the calculation result is equal to or greater than a threshold value. Further, the processing unit 420 determines that there are not a few failures in cooking when the calculation result is smaller than the threshold value.

The information indicating whether the user's failures in cooking are few may be indicated by a numerical value such as success rate. The success rate is also predetermined but may be updated each time the user cooks. When the user inputs information indicating that the time has exceeded the ordinary time by a predetermined period or information indicating that the dish has been burned, for example, the terminal 100 transmits the information on the cooking program executed and the input information to the information processing apparatus 400. The processing unit 420 of the information processing apparatus 400 identifies one or more cooking blocks 530 included in the cooking program received. For each cooking block 530, the processing unit 420 lowers the success rate when the time exceeds the ordinary time by a predetermined period or lowers the success rate when the dish has been burned.

In the information indicating whether the appearance of the cooked dish is affected, “1” indicates that the appearance of the cooked dish is affected, and “0” indicates that the appearance of the cooked dish is not affected, for example. The information indicating whether the appearance of the cooked dish is affected is predetermined.

As has been described, the situation acquisition unit 468 acquires the situation information from the terminal 100 via the communication unit 410 and the network 300. Further, the situation acquisition unit 468 also acquires the request information from the terminal 100 via the communication unit 410 and the network 300.

As described above, the cooking block selection processing unit 466 selects, in each of the plurality of operation blocks 520, the cooking block 530 suited to the user's situation from one or more cooking blocks 530. The cooking block selection processing unit 466 in the previous embodiments calculates the difference between the calculated cooking time and the time available to the user for cooking and selects a sequence that results in a small calculated difference. Thereby, one cooking block 530 is selected for one operation block 520. On the other hand, the cooking block selection processing unit 466 in embodiment 4 calculates the difference between the calculated cooking time and the time available to the user for cooking and selects a sequence that results in a calculated difference equal to or smaller than a predetermined value. Thereby, a plurality of cooking blocks 530 may be selected for one operation block 520.

The cooking block selection processing unit 466 selects the cooking block 530 based on the request information acquired by the situation acquisition unit 468. When the request information indicates that the taste of the dish is prioritized, for example, the cooking block selection processing unit 466 acquires the information indicating whether the user's failures in cooking are few in each of the plurality of cooking blocks 530 included in each sequence. The cooking block selection processing unit 466 integrates the information indicating whether the user's failures in cooking are few for each sequence. The larger the integrated value, the fewer the user's failures in cooking are. Therefore, the cooking block selection processing unit 466 selects a sequence with the largest integrated value. The same process is performed when the information indicating whether the user's failures in cooking are few is indicated by a success rate.

When the request information indicates that the appearance of the dish is prioritized, for example, the cooking block selection processing unit 466 acquires the information indicating whether the appearance of the cooked dish is affected in each of the plurality of cooking blocks 530 included in each sequence. The cooking block selection processing unit 466 integrates the information indicating whether the appearance of the cooked dish is affected for each sequence. The larger the integrated value, the more the appearance of the cooked dish is affected. Therefore, the cooking block selection processing unit 466 selects a sequence with the largest integrated value.

According to this variation, the cooking block 530 includes the information indicating whether user's failures in cooking are few so that a sequence for prioritizing the taste of the dish can be selected. Further, the cooking block 530 includes the information indicating whether the appearance of the cooked dish is affected so that a sequence for prioritizing the appearance of the dish can be selected. Further, a sequence is selected by reflecting the required information so that it is possible to create a cooking step that takes into account the user's purpose.

A summary of an embodiment of the present disclosure is given below. An information processing method according to an embodiment of the present disclosure includes: acquiring a plurality of cooking steps; associating one or more blocks to each of the plurality of cooking steps; acquiring information on a situation of a user; selecting, in each of the plurality of cooking steps, a block suited to the situation of the user from the one or more blocks; creating a cooking program suited to the situation of the user by combining the block selected in each of the plurality of cooking steps; and outputting the cooking program created.

The method may further include: extracting information on an operation related to cooking from each of the plurality of cooking steps. The associating associates each of the plurality of cooking steps with the one or more blocks corresponding to the operation related to cooking.

Correspondence between the operation related to cooking and the one or more blocks may be stored for each operation related to cooking, and the associating may acquire the one or more blocks corresponding to the operation related to cooking, based on the correspondence.

The method may further include acquiring information on a utensil or an ingredient available to the user. Each block may include information on a utensil or an ingredient to be used to execute the block, and the selecting may select the block that uses the utensil or the ingredient available to the user, based on the information on the utensil or the ingredient available to the user and the information on the utensil or the ingredient to be used to execute the block.

Each block may include one of first information indicating a degree of involvement of the user in cooking corresponding to the block and second information indicating that involvement of the user required for cooking corresponding to the cooking block is less than the degree of involvement in the first information, the information on the situation of the user may include at least one of a first flag indicating that the user can execute the block of the first information and the second information or a second flag indicating that the user can execute the block of the second information but cannot execute the block of the first information, and the selecting may select the block including the first information when the information on the situation of the user indicates the first flag and select the block including the second information when the information on the situation of the user indicates the second flag.

The selecting may count the number of types including the utensil and the ingredient to be used, based on the information on the utensil or the ingredient to be used to execute the block, and select the block, in the plurality of cooking steps, with a small total number of types.

Each block may include information on a cooking time corresponding to the block, the information on the situation of the user may include information on a time available to the user for cooking, and the selecting may calculate a difference between a cooking time resulting when the blocks for each of the plurality of cooking steps are combined and the time available to the user for cooking and select the block that results in a small calculated difference.

Each block may include information on a cooking time corresponding to the block, the information on the situation of the user may include information on a time available to the user for cooking, and the selecting may select the block so that a cooking time resulting when the blocks for each of the plurality of cooking steps are combined is close to the time available to the user for cooking.

The selecting may count the number of types including the utensil and the ingredient to be used, based on the information on the utensil or the ingredient to be used to execute the block, and select the block, in the plurality of cooking steps, with a small total number of types.

Another embodiment of the present disclosure relates to an information processing apparatus. The apparatus includes: a first acquisition unit that acquires a plurality of cooking steps; a first processor that associates one or more blocks to each of the plurality of cooking steps; a second acquisition unit that acquires information on a situation of a user; a second processor that selects, in each of the plurality of cooking steps, a block suited to the situation of the user from the one or more blocks; a third processor that creates a cooking program suited to the situation of the user by combining the block selected in each of the plurality of cooking steps; and an output unit that outputs the cooking program created.

The present disclosure has been described above based on an exemplary embodiment. The exemplary embodiment intended to be illustrative only and it will be understood by those skilled in the art that various modifications to combinations of constituting elements and processes are possible and that such modifications are also within the scope of the present disclosure.

What is claimed is:

1. An information processing method comprising:
acquiring a plurality of cooking steps;
associating one or more blocks to each of the plurality of cooking steps;
acquiring information on a situation of a user;
selecting, in each of the plurality of cooking steps, a block suited to the situation of the user from the one or more blocks;
creating a cooking program suited to the situation of the user by combining the block selected in each of the plurality of cooking steps; and
outputting the cooking program created.

2. The information processing method according to claim 1, further comprising:
extracting information on an operation related to cooking from each of the plurality of cooking steps,
wherein the associating associates each of the plurality of cooking steps with the one or more blocks corresponding to the operation related to cooking.

3. The information processing method according to claim 2,
wherein correspondence between the operation related to cooking and the one or more blocks is stored for each operation related to cooking, and
wherein the associating acquires the one or more blocks corresponding to the operation related to cooking, based on the correspondence.

4. The information processing method according to claim 3, further comprising:
acquiring information on a utensil or an ingredient available to the user,
wherein each block includes information on a utensil or an ingredient to be used to execute the block,
wherein the selecting selects the block that uses the utensil or the ingredient available to the user, based on the information on the utensil or the ingredient available to the user and the information on the utensil or the ingredient to be used to execute the block.

5. The information processing method according to claim 4,
wherein each block includes one of first information indicating a degree of involvement of the user in cooking corresponding to the block and second information indicating that involvement of the user required for cooking corresponding to the cooking block is less than the degree of involvement in the first information,
wherein the information on the situation of the user includes at least one of a first flag indicating that the user can execute the block of the first information and the second information or a second flag indicating that the user can execute the block of the second information but cannot execute the block of the first information, and
wherein the selecting selects the block including the first information when the information on the situation of the user indicates the first flag and selects the block including the second information when the information on the situation of the user indicates the second flag.

6. The information processing method according to claim 5,
wherein the selecting counts the number of types including the utensil and the ingredient to be used, based on the information on the utensil or the ingredient to be used to execute the block, and selects the block, in the plurality of cooking steps, with a small total number of types.

7. The information processing method according to claim 6,
wherein each block includes information on a cooking time corresponding to the block,
wherein the information on the situation of the user includes information on a time available to the user for cooking, and
wherein the selecting calculates a difference between a cooking time resulting when the blocks for each of the plurality of cooking steps are combined and the time available to the user for cooking and selects the block that results in a small calculated difference.

8. The information processing method according to claim 5,
wherein each block includes information on a cooking time corresponding to the block,
wherein the information on the situation of the user includes information on a time available to the user for cooking, and
wherein the selecting selects the block so that a cooking time resulting when the blocks for each of the plurality of cooking steps are combined is close to the time available to the user for cooking.

9. The information processing method according to claim 8,
wherein the selecting counts the number of types including the utensil and the ingredient to be used, based on the information on the utensil or the ingredient to be used to execute the block, and selects the block, in the plurality of cooking steps, with a small total number of types.

10. An information processing apparatus comprising:
a first acquisition unit that acquires a plurality of cooking steps;
a first processor that associates one or more blocks to each of the plurality of cooking steps;
a second acquisition unit that acquires information on a situation of a user;
a second processor that selects, in each of the plurality of cooking steps, a block suited to the situation of the user from the one or more blocks;
a third processor that creates a cooking program suited to the situation of the user by combining the block selected in each of the plurality of cooking steps; and
an output unit that outputs the cooking program created.

11. A program comprising computer-implemented modules including:
a module that acquires a plurality of cooking steps;
a module that associates one or more blocks to each of the plurality of cooking steps;
a module that acquires information on a situation of a user;
a module that selects, in each of the plurality of cooking steps, a block suited to the situation of the user from the one or more blocks;
a module that creates a cooking program suited to the situation of the user by combining the block selected in each of the plurality of cooking steps; and
a module that outputs the cooking program created.
